(19) United States
(12) Patent Application Publication
(10) Pub. No.: US 2017/0213459 A1
(43) Pub. Date: Jul. 27, 2017

(54) SYSTEM AND METHOD OF IDENTIFYING A VEHICLE AND DETERMINING THE LOCATION AND THE VELOCITY OF THE VEHICLE BY SOUND

(71) Applicant: Flex Ltd., Singapore (SG)

(72) Inventor: Ronald S. Ogaz, Los Gatos, CA (US)

(21) Appl. No.: 15/412,813

(22) Filed: Jan. 23, 2017

Related U.S. Application Data
(60) Provisional application No. 62/286,134, filed on Jan. 22, 2016.

(51) Int. Cl. G08G 1/0967; G08G 1/0965; G08G 1/16; G01S 5/22; G05D 1/02

(52) U.S. Cl. CPC G08G 1/096725; G01S 5/22; G05D 1/0214; G05D 1/0255; G08G 1/166; G08G 1/0965

(57) ABSTRACT

A vehicle control system can determine a location and/or vector of a second vehicle by analyzing sounds received from the second vehicle. The vehicle control system can automatically configure the instrument display to indicate the location of the second vehicle to the vehicle operator. The vehicle control system can also provide a warning of an approaching emergency vehicle (law enforcement, medical, fire) to the vehicle operator. For example, the vehicle control system may generate and provide an alert that includes information related to traffic actions to take to avoid, or make way for, the approaching emergency vehicle.

### CROSS REFERENCE TO RELATED APPLICATION

The present application claims the benefits of and priority, under 35 U.S.C. §119(e), to U.S. Provisional Application Ser. No. 62/286,134, filed Jan. 22, 2016, entitled “SYSTEM AND METHOD OF IDENTIFYING A VEHICLE AND DETERMINING THE LOCATION AND THE VELOCITY OF THE VEHICLE BY SOUND,” which is incorporated herein by reference in its entirety for all that it teaches and for all purposes.

### FIELD

The present disclosure relates generally to a novel system and method of locating the position and velocity of an object by sound.

### BACKGROUND

Distracted drivers listening to music or people with hearing disabilities may not know when an emergency vehicle is approaching. It would be advantageous for a driver of an automobile or other vehicle to know the location and velocity of an approaching emergency vehicle or other vehicle, regardless of the interior environment of the vehicle. The interiors of modern vehicle typically include sound insulation to provide a quiet and comfortable user environment, operators of vehicles may not be able to hear sounds produced by other vehicles. Information related to sounds received from other vehicles would be especially helpful to drivers of vehicles who are deaf and hard of hearing.

### BRIEF DESCRIPTION OF THE DRAWINGS

FIG. 1 depicts an embodiment of a vehicle operating environment;

FIG. 2 is a block diagram of an embodiment of a vehicle system;

FIG. 3 is a block diagram of an embodiment of a vehicle control system environment;

FIG. 4 is a block diagram of an embodiment of a vehicle communications subsystem;

FIG. 5A depicts an embodiment of a sensor configuration for a vehicle;

FIG. 5B depicts an embodiment of a sensor configuration for a portion of the interior of a vehicle;

FIG. 6A is a block diagram of an embodiment of interior sensors for a vehicle;

FIG. 6B is a block diagram of an embodiment of exterior sensors for a vehicle;

FIG. 6C is a block diagram of an embodiment of a sound sensor array for a vehicle;

FIG. 7A is a block diagram of an embodiment of a media subsystem for a vehicle;

FIG. 7B is a block diagram of an embodiment of a user and device interaction subsystem for a vehicle;

FIG. 8 is a block diagram of an embodiment of a navigation subsystem for a vehicle;

FIG. 9 is a block diagram of an embodiment of a software architecture for the vehicle control system;

FIG. 10A is a graphical representation of a driving environment for a vehicle receiving a sound signal from another vehicle;

FIG. 10B is another graphical representation of a driving environment for a vehicle receiving a sound signal from another vehicle;

FIG. 10C is a block diagram of software components executed by a processor of a vehicle control system;

FIG. 10D is a block diagram of data that may be stored in the vehicle;

FIG. 10E is a representation of a user interface provided in the vehicle;

FIG. 11 is a graphical representation of an embodiment of a mathematical model to determine a location and/or vector of another vehicle emanating a sound signal;

FIG. 12 is a graphical representation of an embodiment of a sound signal received from a static vehicle, and approaching vehicle, and/or a withdrawing vehicle;

FIG. 13 is a flow or process diagram of a method for determining a location and/or vector of another vehicle emanating a sound signal.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference letter or label.

### DETAILED DESCRIPTION

Presented herein are embodiments of systems, devices, processes, data structures, user interfaces, etc. The embodiments may relate to an automobile and/or an automobile environment. The automobile environment can include systems associated with the automobile and devices or other systems in communication with the automobile and/or automobile systems. Embodiments of systems and methods are presented herein for determining and/or locating, by a first vehicle, the position and velocity of a second vehicle or another object from sounds received by multiple sensors of the first vehicle. In some circumstances, the first vehicle can identify the type of second vehicle from signal processing. For example, the first vehicle can determine if the second vehicle is an emergency vehicle (e.g., policy, medical, fire. etc.) or a private vehicle (e.g., passenger car, commercial truck, etc.) by analyzing sounds received from a siren and/or a horn of the second vehicle.

A vehicle control system may identify the source of sounds, a location of the source of the sounds, and/or a velocity of the source of the sounds. Sensors associated with the vehicle receive sounds from other vehicle or objects. The sounds are received at different times by different sensors. A processor of the vehicle control system can determine the location and velocity of the other vehicle or object based on differences in the times that each sensor receives the sounds and frequency shifts of the sounds received by each sensor.

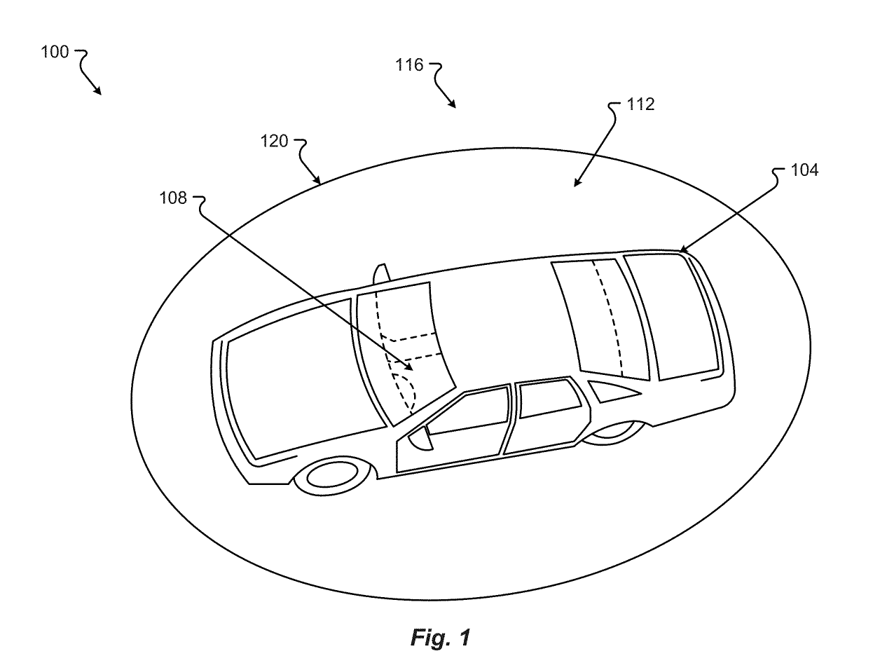

A vehicle environment 100 that may contain a vehicle ecosystem is shown in FIG. 1. The vehicle environment 100 can contain areas associated with a vehicle or conveyance 104. The vehicle 104 is shown as a car but can be any type of conveyance. The environment 100 can include at least three zones. A first zone 108 may be inside a vehicle 104. The zone 108 includes any interior space, trunk space, engine compartment, or other associated space within or associated with the vehicle 104. The interior zone 108 can be defined by one or more techniques, for example, geo-fencing.

A second zone 112 may be delineated by line 120. The zone 112 is created by a range of one or more sensors associated with the vehicle 104. Thus, the area 112 is exemplary of the range of those sensors and what can be detected by those sensors associated with the vehicle 104. Although sensor range is shown as a fixed and continuous oval, the sensor range may be dynamic and/or discontinuous. For example, a ranging sensor (e.g., radar, lidar, ladar, etc.) may provide a variable range depending on output power, signal characteristics, or environmental conditions (e.g., rain, fog, clear, etc.). The rest of the environment includes all space beyond the range of the sensors and is represented by space 116. Thus, the environment 100 may have an area 116 that includes all areas beyond the sensor range 112. The area 116 may include locations of travel that the vehicle 104 may proceed to in the future.

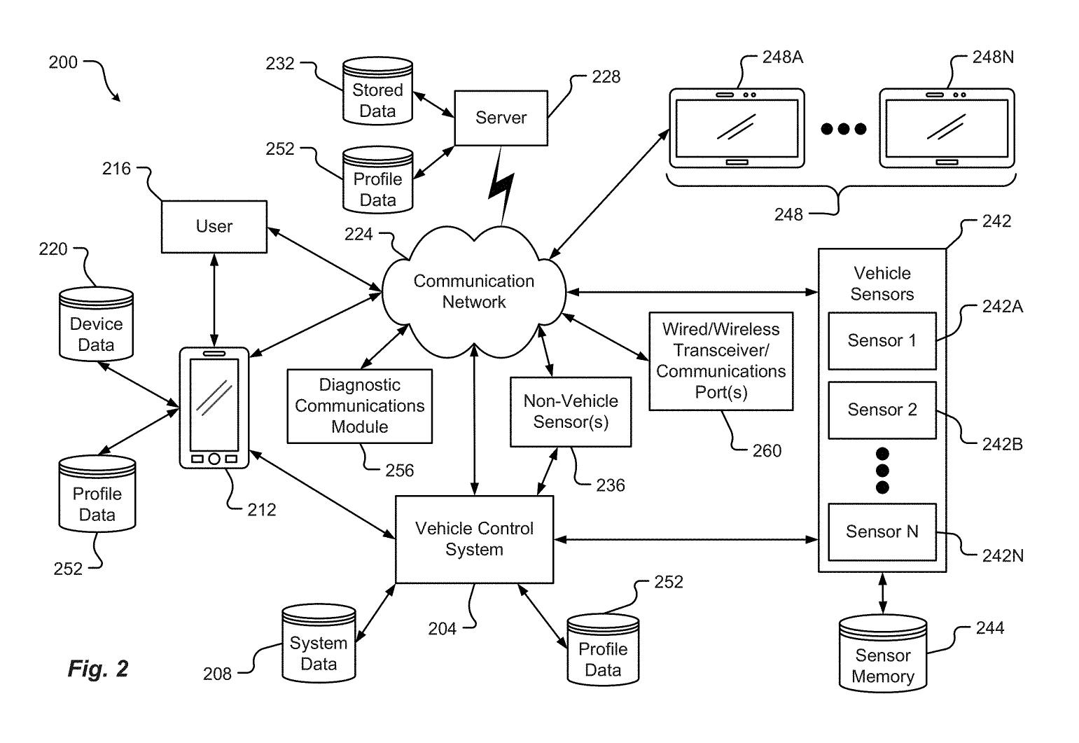

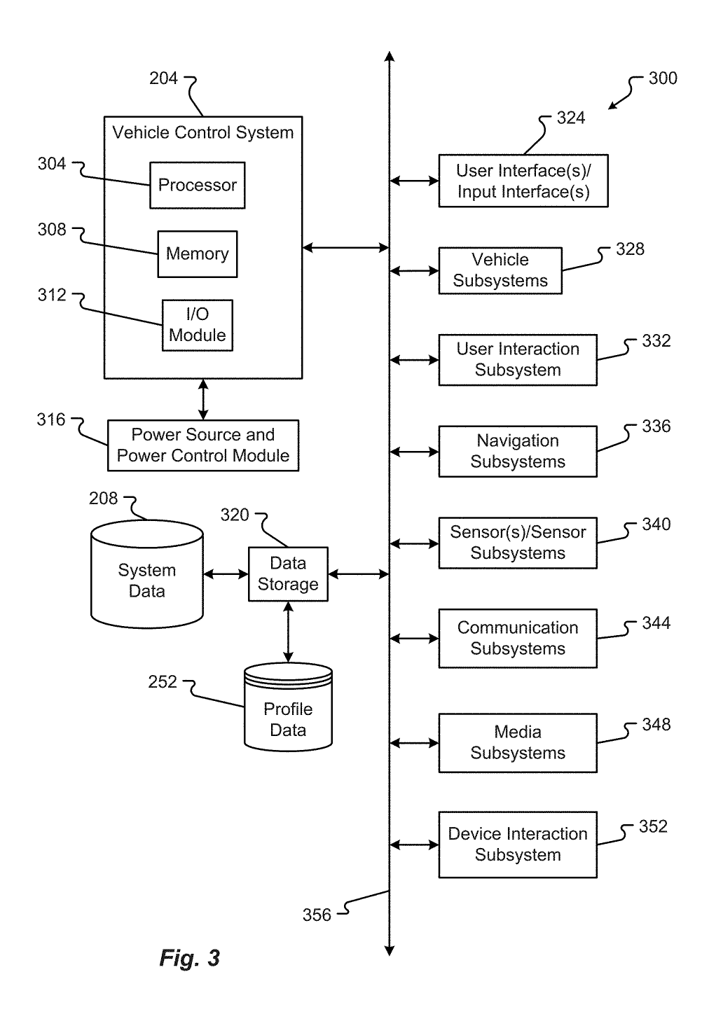

An embodiment of a vehicle system 200 is shown in FIG. 2. The vehicle system 200 may comprise hardware and/or software that conduct various operations for or with the vehicle 104. The operations can include, but are not limited to, providing information to the user 216, receiving input from the user 216, and controlling the functions or operation of the vehicle 104, etc. The vehicle system 200 can include a vehicle control system 204. The vehicle control system 204 can be any type of computing system operable to conduct the operations as described herein. An example of a vehicle control system may be as described in conjunction with FIG. 3.

The vehicle control system 204 may interact with a memory or storage system 208 that stores system data. System data 208 may be any type of data needed for the vehicle control system 204 to control effectively the vehicle 104. The system data 208 can represent any type of database or other storage system. Thus, the system data 208 can be a flat file data system, an object-oriented data system, or some other data system that may interface with the vehicle control system 204.

The vehicle control system 204 may communicate with a device or user interface 212, 248. The user interface 212, 248 may be operable to receive user input either through touch input, on one or more user interface buttons, via voice command, via one or more image sensors, or through a graphical user interface that may include a gesture capture region, as described in conjunction with the other figures provided herein. Further, the symbol 212, 248 can represent a device that is located or associated with the vehicle 104. The device 212, 248 can be a mobile device, including, but not limited to, a mobile telephone, a mobile computer, or other type of computing system or device that is either permanently located in or temporarily associated with, but not necessarily connected to, the vehicle 104. Thus, the vehicle control system 204 can interface with the device 212, 248 and leverage the device's computing capability to provide one or more of the features or functions as described herein.

The device or user interface 212, 248 can receive input or provide information to a user 216. The user 216 may thus interact with the vehicle control system 204 through the interface or device 212, 248. Further, the device 212, 248 may include or have access to device data 220 and/or profile data 252. The device data 220 can be any type of data that is used in conjunction with the device 212, 248 including, but not limited to, multimedia data, preferences data, device identification information, or other types of data. The profile data 252 can be any type of data associated with at least one user 216 including, but in no way limited to, bioinformatics, medical information, driving history, personal information (e.g., home physical address, business physical address, contact addresses, likes, dislikes, hobbies, size, weight, occupation, business contacts—including physical and/or electronic addresses, personal contacts—including physical and/or electronic addresses, family members, and personal information related thereto, etc.), other user characteristics, advertising information, user settings and feature preferences, travel information, associated vehicle preferences, communication preferences, historical information (e.g., including historical, current, and/or future travel destinations), Internet browsing history, or other types of data. In any event, the data may be stored as device data 220 and/or profile data 252 in a storage system similar to that described in conjunction with FIGS. 12A through 12D.

As an example, the profile data 252 may include one or more user profiles. User profiles may be generated based on data gathered from one or more of vehicle preferences (e.g., seat settings, HVAC settings, dash configurations, and the like), recorded settings, geographic location information (e.g., provided by a satellite positioning system (e.g., GPS), Wi-Fi hotspot, cell tower data, etc.), mobile device information (such as mobile device electronic addresses, Internet browsing history and content, application store selections, user settings and enabled and disabled features, and the like), private information (such as user information from a social network, user presence information, user business account, and the like), secure data, biometric information, audio information from on board microphones, video information from on board cameras, Internet browsing history and browsed content using an on board computer and/or the local area network enabled by the vehicle 104, geographic location information (e.g., a vendor storefront, roadway name, city name, etc.), and the like.

The profile data 252 may include one or more user accounts. User accounts may include access and permissions to one or more settings and/or feature preferences associated with the vehicle 104, communications, infotainment, content, etc. In one example, a user account may allow access to certain settings for a particular user, while another user account may deny access to the settings for another user, and vice versa. The access controlled by the user account may be based on at least one of a user account priority, role, permission, age, family status, a group priority (e.g., the user account priority of one or more users, etc.), a group age (e.g., the average age of users in the group, a minimum age of the users in the group, a maximum age of the users in the group, and/or combinations thereof, etc.).

The vehicle control system 204 may also communicate with or through a communication network 224. The communication network 224 can represent any type of wireless and/or wired communication system that may be included within the vehicle 104 or operable to communicate outside the vehicle 104. Thus, the communication network 224 can include a local area communication capability and a wide area communication capability. For example, the communication network 224 can include a Bluetooth® wireless system, an 802.11x (e.g., 802.11G/802.11N/802.11AC, or the like, wireless system), a CAN bus, an Ethernet network within the vehicle 104, or other types of communication networks that may function with or be associated with the vehicle 104. Further, the communication network 224 can also include wide area communication capabilities, including one or more of, but not limited to, a cellular communication capability, satellite telephone communication capability, a wireless wide area network communication capability, or other types of communication capabilities that allow for the vehicle control system 204 to communicate outside the vehicle 104.

The vehicle control system 204 may communicate through the communication network 224 to a server 228 that may be located in a facility that is not within physical proximity to the vehicle 104. Thus, the server 228 may represent a cloud computing system or cloud storage that allows the vehicle control system 204 to either gain access to further computing capabilities or to storage at a location outside of the vehicle 104. The server 228 can include a computer processor and memory and be similar to any computing system as understood to one skilled in the art.

Further, the server 228 may be associated with stored data 232. The stored data 232 may be stored in any system or by any method, as described in conjunction with system data 208, device data 220, and/or profile data 252. The stored data 232 can include information that may be associated with one or more users 216 or associated with one or more vehicles 104. The stored data 232, being stored in a cloud or in a distant facility, may be exchanged among vehicles 104 or may be used by a user 216 in different locations or with different vehicles 104. Additionally or alternatively, the server may be associated with profile data 252 as provided herein. It is anticipated that the system data 208 and/or profile data 252 may be accessed across the communication network 224 by one or more components of the system 200. Similar to the stored data 232, the system data 208, the profile data 252, being stored in a cloud or in a distant facility, may be exchanged among vehicles 104 or may be used by a user 216 in different locations or with different vehicles 104.

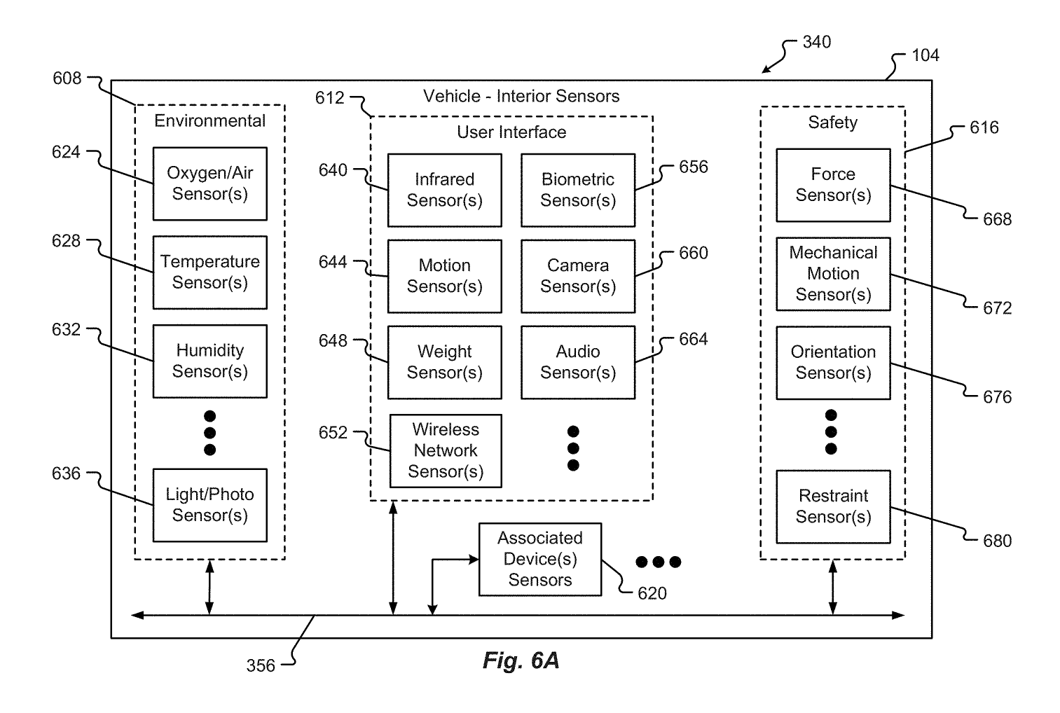

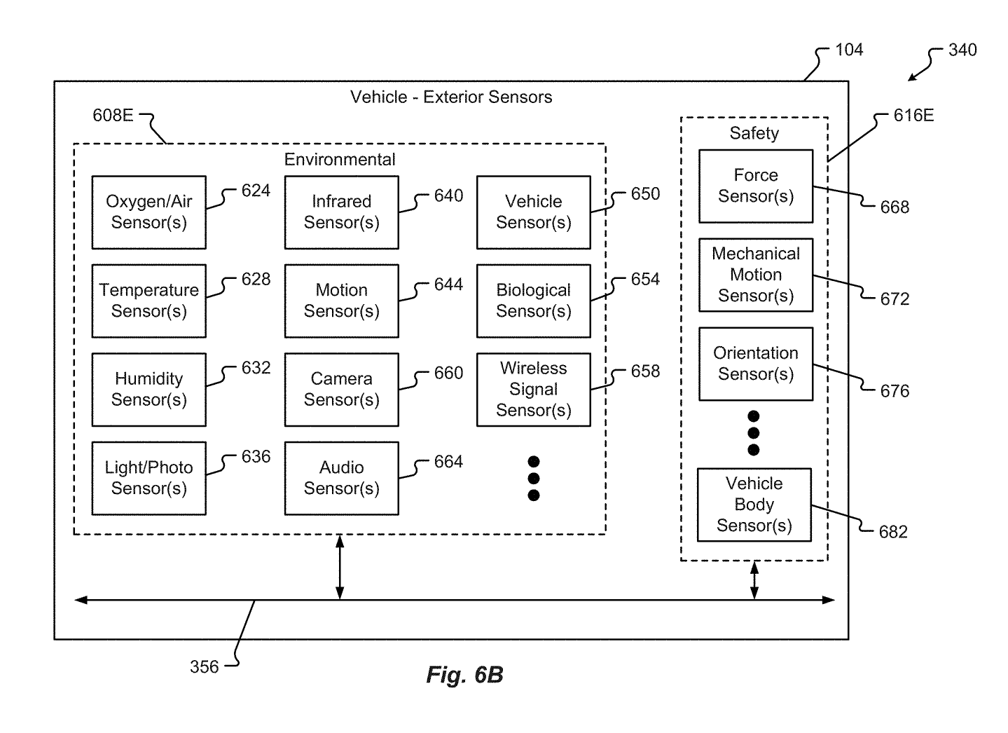

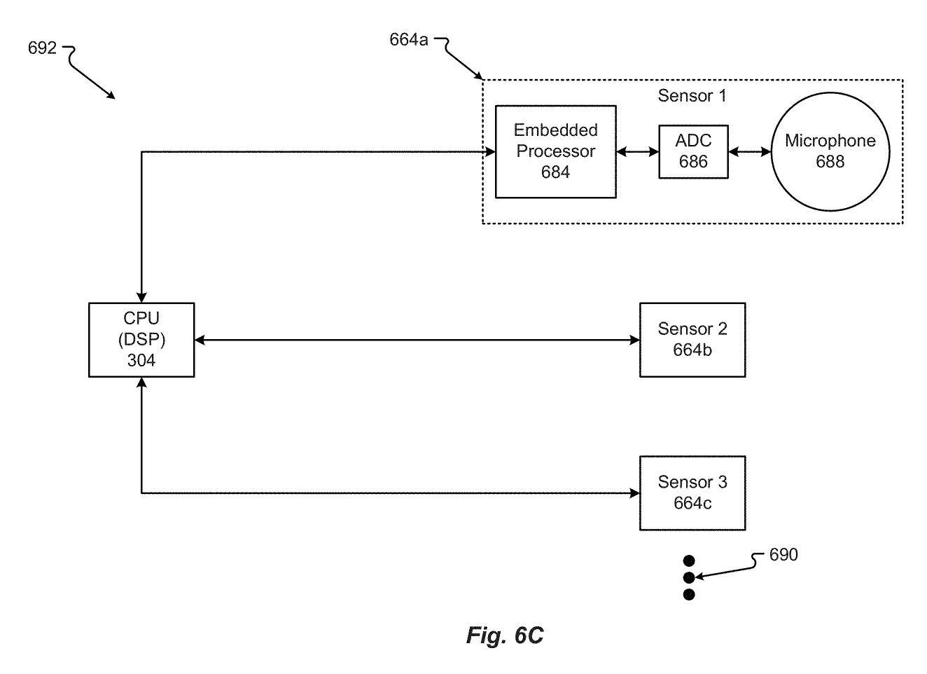

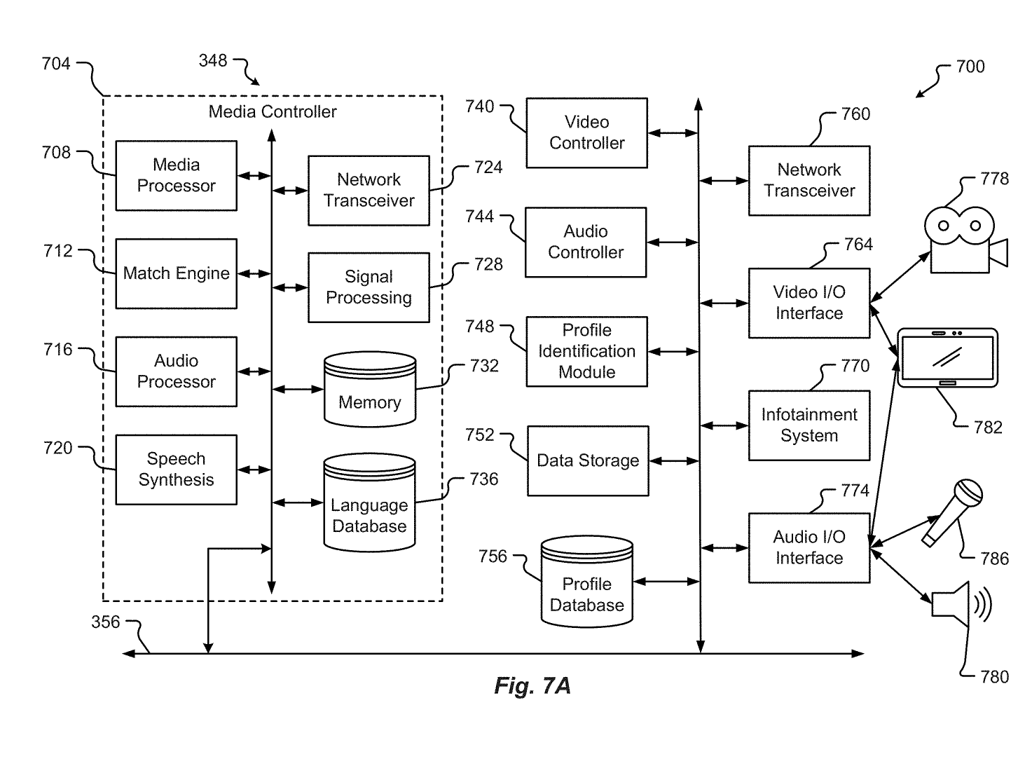

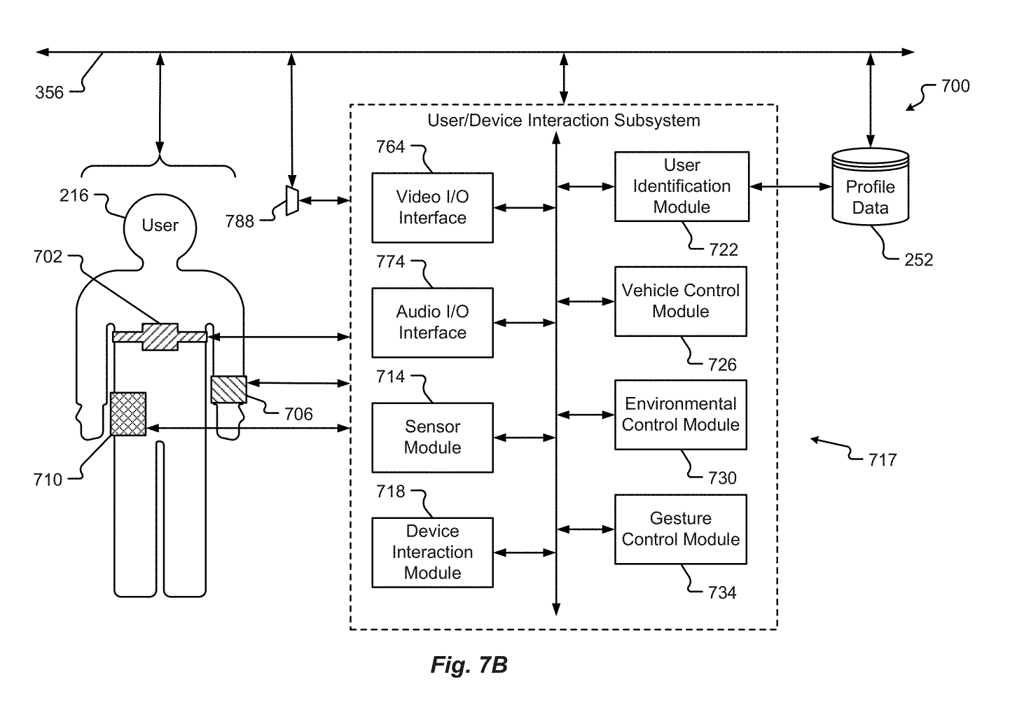

The vehicle control system 204 may also communicate with one or more sensors 236, 242, which are either associated with the vehicle 104 or communicate with the vehicle 104. Vehicle sensors 242 may include one or more sensors for providing information to the vehicle control system 204 that determine or provide information about the environment 100 in which the vehicle 104 is operating. Embodiments of these sensors may be as described in conjunction with FIGS. 6A-7B. Non-vehicle sensor 236 can be any type of sensor that is not currently associated with the vehicle 104. For example, non-vehicle sensor 236 can be sensors in a traffic system operated by a third party that provides data to the vehicle control system 204. Further, the non-vehicle sensor(s) 236 can be other types of sensors which provide information about the distant environment 116 or other information about the vehicle 104 or the environment 100. These non-vehicle sensors 236 may be operated by third parties but provide information to the vehicle control system 204. Examples of information provided by the sensors 236 and that may be used by the vehicle control system 204 may include weather tracking data, traffic data, user health tracking data, vehicle maintenance data, or other types of data, which may provide environmental or other data to the vehicle control system 204. The vehicle control system 204 may also perform signal processing of signals received from one or more sensors 236, 242. Such signal processing may include estimation of a measured parameter from a single sensor, such as multiple measurements of a range state parameter from the vehicle 104 to an obstacle, and/or the estimation, blending, or fusion of a measured state parameter from multiple sensors such as multiple radar sensors or a combination of a ladar/lidar range sensor and a radar sensor. Signal processing of such sensor signal measurements may comprise stochastic signal processing, adaptive signal processing, and/or other signal processing techniques known to those skilled in the art.

The various sensors 236, 242 may include one or more sensor memory 244. Embodiments of the sensor memory 244 may be configured to store data collected by the sensors 236, 242. For example, a temperature sensor may collect temperature data associated with a vehicle 104, user 216, and/or environment, over time. The temperature data may be collected incrementally, in response to a condition, or at specific time periods. In this example, as the temperature data is collected, it may be stored in the sensor memory 244. In some cases, the data may be stored along with an identification of the sensor and a collection time associated with the data. Among other things, this stored data may include multiple data points and may be used to track changes in sensor measurements over time. As can be appreciated, the sensor memory 244 can represent any type of database or other storage system.

The diagnostic communications module 256 may be configured to receive and transmit diagnostic signals and information associated with the vehicle 104. Examples of diagnostics signals and information may include, but is in no way limited to, vehicle system warnings, sensor data, vehicle component status, service information, component health, maintenance alerts, recall notifications, predictive analysis, and the like. Embodiments of the diagnostic communications module 256 may handle warning/error signals in a predetermined manner. The signals, for instance, can be presented to one or more of a third party, occupant, vehicle control system 204, and a service provider (e.g., manufacturer, repair facility, etc.).

Optionally, the diagnostic communications module 256 may be utilized by a third party (i.e., a party other than the user 216, etc.) in communicating vehicle diagnostic information. For instance, a manufacturer may send a signal to a vehicle 104 to determine a status associated with one or more components associated with the vehicle 104. In response to receiving the signal, the diagnostic communications module 256 may communicate with the vehicle control system 204 to initiate a diagnostic status check. Once the diagnostic status check is performed, the information may be sent via the diagnostic communications module 256 to the manufacturer. This example may be especially useful in determining whether a component recall should be issued based on the status check responses returned from a certain number of vehicles.

Wired/wireless transceiver/communications ports 260 may be included. The wired/wireless transceiver/communications ports 260 may be included to support communications over wired networks or links, for example with other communication devices, server devices, and/or peripheral devices. Examples of wired/wireless transceiver/communications ports 260 include Ethernet ports, Universal Serial Bus (USB) ports, Institute of Electrical and Electronics Engineers (IEEE) 1594, or other interface ports.

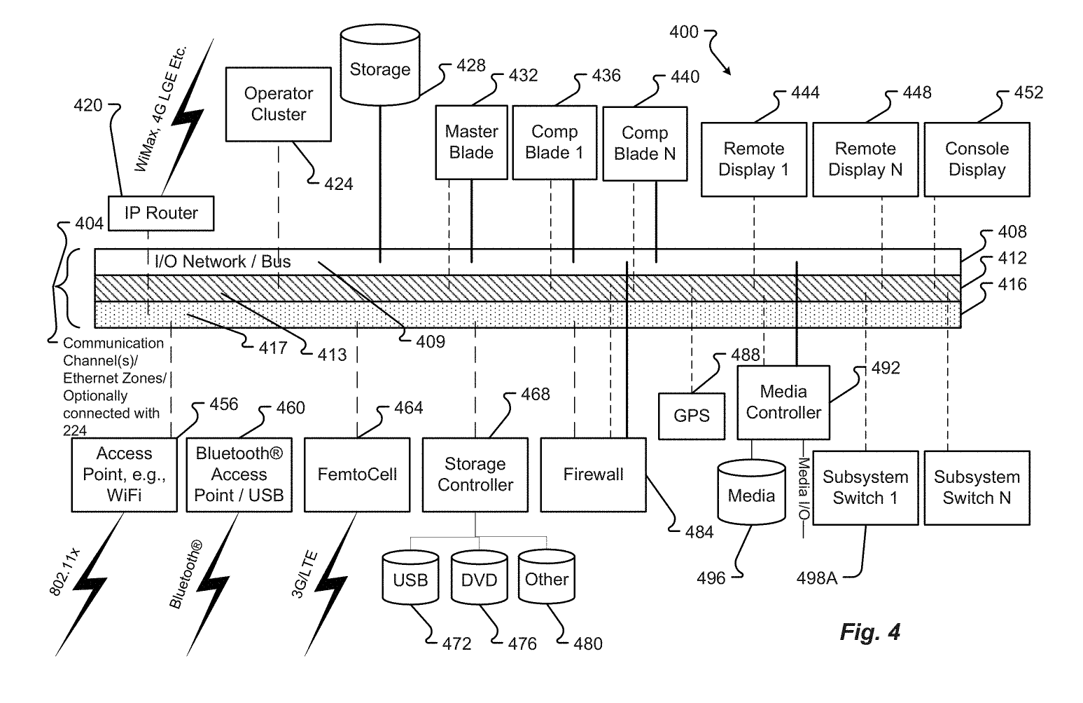

An embodiment of a vehicle control environment 300 including a vehicle control system 204 may be as shown in FIG. 3. Beyond the vehicle control system 204, the vehicle control environment 300 can include one or more of, but is not limited to, a power source and/or power control module 316, a data storage module 320, user interface(s)/input interface(s) 324, vehicle subsystems 328, user interaction subsystems 332, Global Positioning System (GPS)/Navigation subsystems 336, sensor(s) and/or sensor subsystems 340, communication subsystems 344, media subsystems 348, and/or device interaction subsystems 352. The subsystems, modules, components, etc. 316-352 may include hardware, software, firmware, computer readable media, displays, input devices, output devices, etc. or combinations thereof. The system, subsystems, modules, components, etc. 204, 316-352 may communicate over a network or bus 356. This communication bus 356 may be bidirectional and perform data communications using any known or future-developed standard or protocol. An example of the communication bus 356 may be as described in conjunction with FIG. 4.

The vehicle control system 204 can include a processor 304, memory 308, and/or an input/output (I/O) module 312. Thus, the vehicle control system 204 may be a computer system, which can comprise hardware elements that may be electrically coupled. The hardware elements may include one or more central processing units (CPUs) 304; one or more components of the I/O module 312 including input devices (e.g., a mouse, a keyboard, etc.) and/or one or more output devices (e.g., a display device, a printer, etc.).

The processor 304 may comprise a general purpose programmable processor or controller for executing application programming or instructions. The processor 304 may, optionally, include multiple processor cores, and/or implement multiple virtual processors. Additionally or alternatively, the processor 304 may include multiple physical processors. As a particular example, the processor 304 may comprise a specially configured application specific integrated circuit (ASIC) or other integrated circuit, a Field Programmable Gate Array (FPGA), a digital signal processor, a controller, a hardwired electronic or logic circuit, a programmable logic device or gate array, a special purpose computer, or the like. The processor 304 generally functions to run programming code or instructions implementing various functions of the vehicle control system 204.

The input/output module 312 and associated ports may be included to support communications over wired or wireless networks or links, for example with other communication devices, server devices, and/or peripheral devices. Examples of an input/output module 312 include an Ethernet port, a Universal Serial Bus (USB) port, Institute of Electrical and Electronics Engineers (IEEE) 1594, or other interface.

The vehicle control system 204 may also include one or more storage devices 308. By way of example, storage devices 308 may be disk drives, optical storage devices, solid-state storage devices such as a random access memory (“RAM”) and/or a read-only memory (“ROM”), which can be programmable, flash-updateable and/or the like. The vehicle control system 204 may additionally include a computer-readable storage media reader; a communications system (e.g., a modem, a network card (wireless or wired), an infra-red communication device, etc.); and working memory 308, which may include RAM and ROM devices as described above. The vehicle control system 204 may also include a processing acceleration unit, which can include a digital signal processor (DSP), a special-purpose processor, and/or the like.

The computer-readable storage media reader can further be connected to a computer-readable storage medium, together (and, optionally, in combination with storage device(s)) comprehensively representing remote, local, fixed, and/or removable storage devices plus storage media for temporarily and/or more permanently containing computer-readable information. The communications system may permit data to be exchanged with an external or internal network and/or any other computer or device described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, and/or other machine readable mediums for storing information.

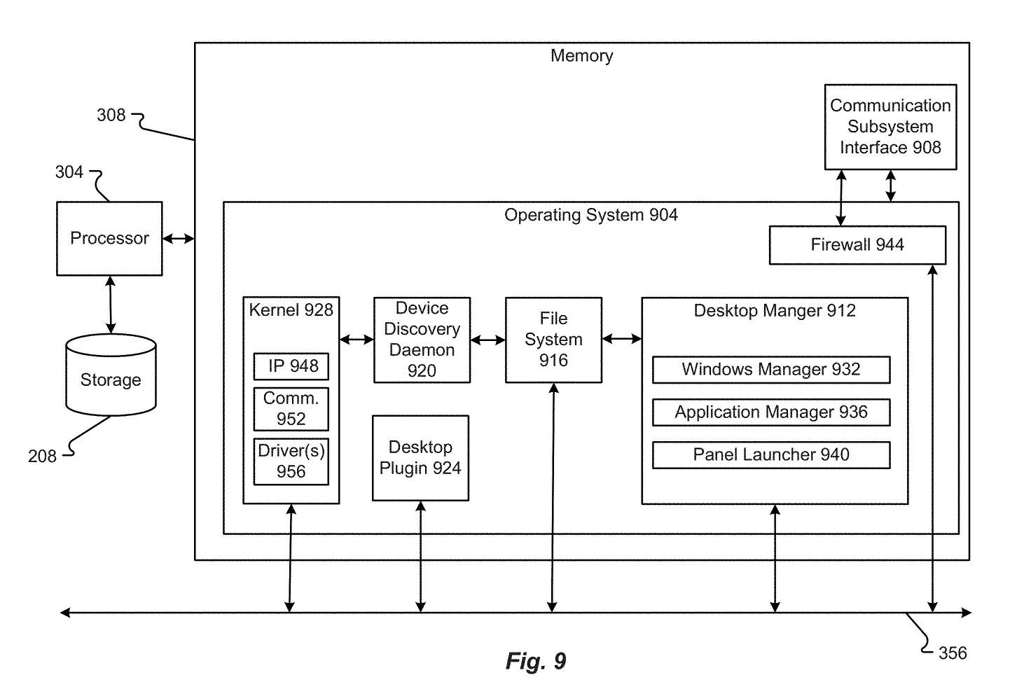

The vehicle control system 204 may also comprise software elements including an operating system and/or other code, as described in conjunction with FIG. 9. It should be appreciated that alternates to the vehicle control system 204 may have numerous variations from that described herein. For example, customized hardware might also be used and/or particular elements might be implemented in hardware, software (including portable software, such as applets), or both. Further, connection to other computing devices such as network input/output devices may be employed.

The power source and/or power control module 316 can include any type of power source, including, but not limited to, batteries, alternating current sources (from connections to a building power system or power line), solar cell arrays, etc. One or more components or modules may also be included to control the power source or change the characteristics of the provided power signal. Such modules can include one or more of, but is not limited to, power regulators, power filters, alternating current (AC) to direct current (DC) converters, DC to AC converters, receptacles, wiring, other converters, etc. The power source and/or power control module 316 functions to provide the vehicle control system 204 and any other system with power.

The data storage 320 can include any module for storing, retrieving, and/or managing data in one or more data stores and/or databases. The database or data stores may reside on a storage medium local to (and/or resident in) the vehicle control system 204 or in the vehicle 104. Alternatively, some of the data storage capability may be remote from the vehicle control system 204 or automobile, and in communication (e.g., via a network) to the vehicle control system 204. The database or data stores may reside in a storage-area network (“SAN”) familiar to those skilled in the art. Similarly, any necessary files for performing the functions attributed to the vehicle control system 204 may be stored locally on the respective vehicle control system 204 and/or remotely, as appropriate. The databases or data stores may be a relational database, and the data storage module 320 may be adapted to store, update, and retrieve data in response to specifically-formatted commands. The data storage module 320 may also perform data management functions for any flat file, object oriented, or other type of database or data store.

A first data store that may be part of the vehicle control environment 300 is a profile data store 252 for storing data about user profiles and data associated with the users. A system data store 208 can include data used by the vehicle control system 204 and/or one or more of the components 324-352 to facilitate the functionality described herein.

The user interface/input interfaces 324 may be as described herein for providing information or data and/or for receiving input or data from a user. Vehicle systems 328 can include any of the mechanical, electrical, electromechanical, computer, or other systems associated with the function of the vehicle 100. For example, vehicle systems 328 can include one or more of, but is not limited to, the steering system, the braking system, the engine and engine control systems, the electrical system, the suspension, the drive train, the cruise control system, the radio, the heating, ventilation, air conditioning (HVAC) system, the windows and/or doors, etc. These systems are well known in the art and will not be described further.

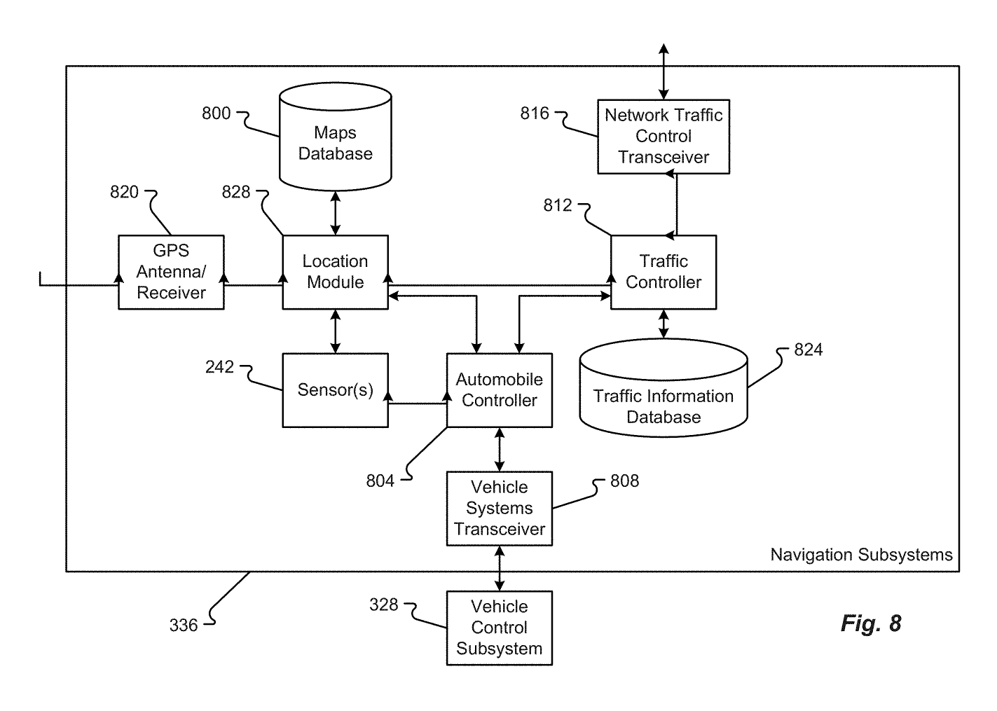

Examples of the other systems and subsystems 324-352 may be as described further herein. For example, the user interface(s)/input interface(s) 324 may be as described in FIGS. 2; the vehicle subsystems 328 may be as described in FIG. 6a et. seq.; the user interaction subsystem 332 may be as described in conjunction with the user/device interaction subsystem 717 of FIG. 7B; the Navigation subsystem 336 may be as described in FIGS. 6A and 8C; the sensor(s)/sensor subsystem 340 may be as described in FIG. 8; the communication subsystem 344 may be as described in FIGS. 2, 4, and 9; the media subsystem 348 may be as described in FIG. 7A; and, the device interaction subsystem 352 may be as described in FIG. 2 and in conjunction with the user/device interaction subsystem 717 of FIG. 7B.

FIG. 4 illustrates an optional communications channel architecture 400 and associated communications components. FIG. 4 illustrates some of the optional components that can be interconnected via the communication channels/zones 404. Communication channels/zones 404 can carry information on one or more of a wired and/or wireless communications link with, in the illustrated example, there being three communications channels/zones, 408, 412, and 416.

This optional environment 400 can also include an IP router 420, an operator cluster 424, one or more storage devices 428, one or more blades, such as master blade 432, and computational blades 436 and 440. Additionally, the communications channels/zones 404 can interconnect one or more displays, such as, remote display 1 444, remote display N 448, and console display 452. The communications channels/zones 404 also interconnect an access point 456, a Bluetooth® access point/USB hub 460, a Femtocell 464, a storage controller 468, that is connected to one or more of USB devices 472, DVDs 476, or other storage devices 480. To assist with managing communications within the communication channel, the environment 400 optionally includes a firewall 484 which will be discussed hereinafter in greater detail. Other components that could also share the communications channel/zones 404 include GPS 488, media controller 492, which is connected to one or more media sources 496, and one or more subsystems, such as subsystem switches 498.

Optionally, the communications channels/zones 404 can be viewed as an I/O network or bus where the communications channels are carried on the same physical media. Optionally, the communication channels 404 can be split amongst one or more physical media and/or combined with one or more wireless communications protocols. Optionally, the communications channels 404 can be based on wireless protocols with no physical media interconnecting the various elements described herein.

The environment 400 shown in FIG. 4 can include a collection of blade processors that are housed in a “crate.” The crate can have a PC-style backplane connector 408 and a backplane Ethernet 408 that allows the various blades to communicate with one another using, for example, an Ethernet.

Various other functional elements illustrated in FIG. 4 can be integrated into this crate architecture with, as discussed hereinafter, various zones utilized for security. Optionally, as illustrated in FIG. 4, the backplane 404/408 can have two separate Ethernet zones that may or may not be on the same communications channel. Optionally, the zones exist on a single communications channel on the I/O network/bus 408. Optionally, the zones are on different communications channels, e.g., 412, 416; however, the implementation is not restricted to any particular type of configuration. Rather, as illustrated in FIG. 4, there can be a red zone 417 and a green zone 413, and the I/O backplane on the network/bus 408 that enables standard I/O operations. This backplane or I/O network/bus 408 also optionally can provide power distribution to the various modules and blades illustrated in FIG. 4. The red and green Ethernet zones, 417 and 413 respectively, can be implemented as Ethernet switches, with one on each side of the firewall 484. Two Ethernets (untrusted and trusted) are not connected in accordance with an optional embodiment. Optionally, the connector geometry for the firewall can be different for the Ethernet zones than for the blades that are a part of the system.

The red zone 417 only needs to go from the modular connector to the input side of the backplane connector of the firewall 484. While FIG. 4 indicates that there are five external red zone connectors to the firewall 484, provisions can be made for any number of ports with the connections being made at the access point 456, the Bluetooth® access point (combo controller) 460, Femtocell 464, storage controller 468, and/or firewall 484. Optionally, the external port connections can be made through a manufacturer configurable modular connector panel, and one or more of the red zone Ethernet ports could be available through a customer supplied crate which allows, for example, wired Ethernet connections from a bring-your-own-device (BYOD) to the firewall 484.

The green zone 413 goes from the output side of the firewall 484 and generally defines the trusted Ethernet. The Ethernet on the backplane 408 essentially implements an Ethernet switch for the entire system, defining the Ethernet backbone of the vehicle 104. All other modules, e.g., blades, etc., can connect to a standard backplane bus and the trusted Ethernet. Some number of switch ports can be reserved to connect to an output modular connector panel to distribute the Ethernet throughout the vehicle 104, e.g., connecting such elements as the console display 452, remote displays 444, 448, GPS 488, etc. Optionally, only trusted components, either provided or approved by the manufacturer after testing, can be attached to the green zone 413, which is by definition in the trusted Ethernet environment.

Optionally, the environment 400, shown in FIG. 4, utilizes IPv6 over Ethernet connections wherever possible. Using, for example, the Broadcom single-twisted pair Ethernet technology, wiring harnesses are simplified and data transmission speeds are maximized. However, while the Broadcom single-twisted pair Ethernet technology can be used, in general, systems and methods can work comparably well with any type of well-known Ethernet technology or other comparable communications technology.

As illustrated in FIG. 4 the I/O network/bus 408 is a split-bus concept that contains three independent bus structures:
The red zone 417—the untrusted Ethernet environment. This zone 417 may be used to connect network devices and customer provided devices to the vehicle information system with these devices being on the untrusted side of the firewall 484.
The green zone 413—the trusted Ethernet environment, this zone 413 can be used to connect manufacturer certified devices such as GPS units, remote displays, subsystem switches, and the like, to the vehicle network 404. Manufacturer certified devices can be implemented by vendors that allow the vehicle software system to validate whether a device is certified to operate with the vehicle 100. Optionally, only certified devices are allowed to connect to the trusted side of the network.
The I/O bus 409—the I/O bus may be used to provide power and data transmission to bus-based devices such as the vehicle solid state drive, the media controller blade 492, the computational blades 436, 440, and the like.
As an example, the split-bus structure can have the following minimum configuration:
Two slots for the red zone Ethernet;
One slot for built-in LTE/WiMax access 420 from the car to other network resources such as the cloud/Internet;
One slot for user devices or bring-your-own device access, this slot can implement, for example, WiFi, Bluetooth®, and/or USB connectivity 456, which can be provided in, for example, the customer crate;
One slot for combined red zone and green zone Ethernet, this slot can be reserved for the firewall controller;
Two slots for computational blades. Here the two computation blades are illustratively as shown the optional master blade and the multimedia blade or controller 492 which can be provided as standard equipment; and

The expansion controller that allows the I/O bus to be extended and provides additional Ethernet switch ports for one or more of the red or green zones, which may require that the basic green zone Ethernet switch implementation will support additional ports beyond the initial three that are needed for the basic exemplary system.

It should be possible to build 8 or 16 or more Ethernet switches that allow for the expansion with existing component(s) in a straight-forward manner.

The red zone 417 can be implemented as an 8-port Ethernet switch that has three actual bus ports within the crate with the remaining five ports being available on the customer crate. The crate implements red zone slots for the firewall controller 484, the combo controller which includes WiFi, Bluetooth®, USB hub (456, 460) and the IP router 420.

The firewall controller 484 can have a dedicated slot that bridges the red zone 417, green zone 413, and uses the I/O bus for power connections. In accordance with an optional low cost implementation, the firewall 484 can be implemented by a dummy module that simply bridges the red zone 417 and the green zone 413 without necessarily providing any firewall functionality. The combo controller 460 that includes the WiFi, Bluetooth®, and USB hub can be provided for consumer device connections. This controller can also implement the IPv6 (un-routable) protocol to ensure that all information is packetized for transmission via IP over the Ethernet in the I/O network/bus 408.

The combo controller 460 with the USB hub can have ports in the customer crate. The combo controller 460 can implement USB discovery functions and packetizes the information for transmission via IP over Ethernet. The combo controller 460 can also facilitate installation of the correct USB driver for the discovered device, such as a BYOD from the user. The combo controller 460 and USB hub can then map the USB address to a “local” IPv6 address for interaction with one or more of the computational blades which is generally going to be the media controller 492.

The IP router 420 can implement Internet access through a manufacturer provided service. This service can allow, for example, a manufacturer to offer value-added services to be integrated into the vehicle information systems. The existence of the manufacturer provided Internet access can also allow the “e-Call” function and other vehicle data recorder functions to be implemented. IP router 420 also allows, for example, WiMax, 4G LTE, and other connections to the Internet through a service provider that can be, for example, contracted by the manufacturer. Internally, the IP router 420 can allow cellular handset connections to the Internet through a Femtocell 464 that is part of the IP router implementation. The IP router 420, with the Femtocell 464, can also allow a cone of silence functionality to be implemented. The IP router 420 can be an optional component for a vehicle provided by, for example, the manufacturer, a dealer, or installed by a user. In the absence of the IP router 420, it is possible to connect a consumer handheld device to the I/O network/bus 408 using, for example, either WiFi or Bluetooth® 456, 460. While functionality may be somewhat reduced when using a handheld device instead of a built-in Ethernet connection, systems and methods of this invention can also work utilizing this consumer handheld device which then connects to the Internet via, for example, WiMax, 4G, 4G LTE, or the like.

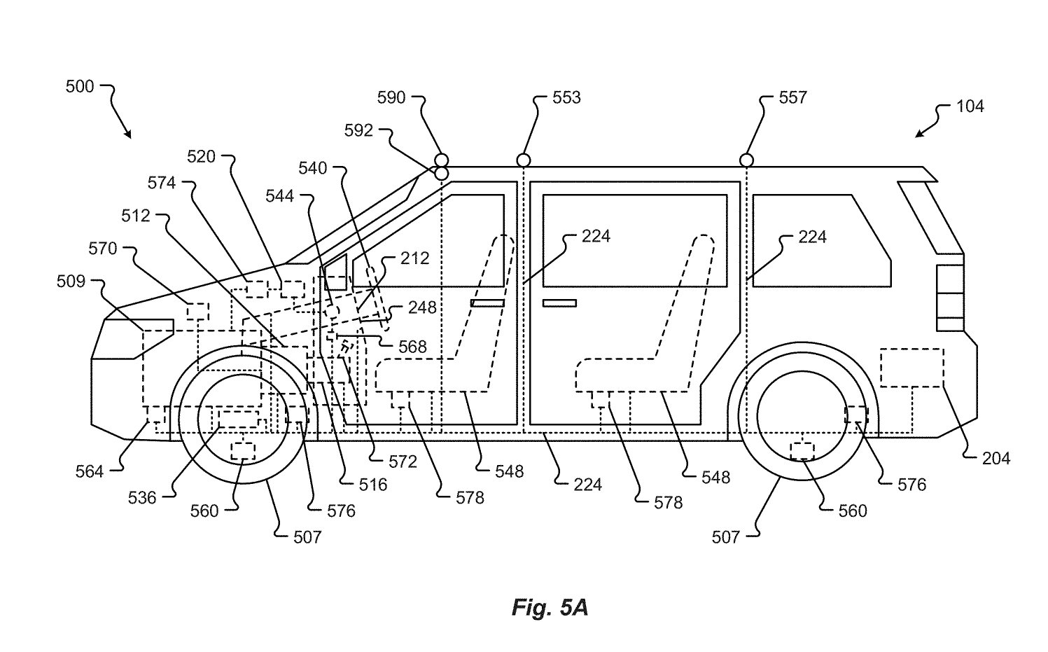

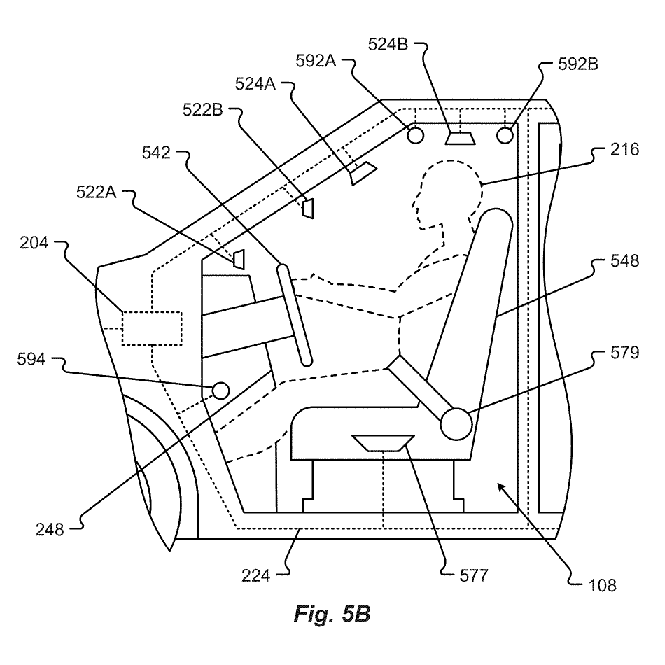

FIGS. 5A-5C show configurations of a vehicle 104. In general, a vehicle 104 may provide functionality based at least partially on one or more areas, zones, and distances, associated with the vehicle 104. Non-limiting examples of this functionality are provided herein below.

An arrangement or configuration for sensors within a vehicle 104 is as shown in FIG. 5A. The sensor arrangement 500 can include one or more areas within the vehicle. An area can be a larger part of the environment inside or outside of the vehicle 104. Thus, area one may include the area within the trunk space or engine space of the vehicle 104 and/or the front passenger compartment. Area two may include a portion of the interior space 108 (e.g., a passenger compartment, etc.) of the vehicle 104. The area N, may include the trunk space or rear compartment area, when included within the vehicle 104. The interior space 108 may also be divided into other areas. Thus, one area may be associated with the front passenger's and driver's seats, a second area may be associated with the middle passengers' seats, and a third area may be associated with a rear passenger's seat. Each area may include one or more sensors that are positioned or operate to provide environmental information about that area 508.

Each area may be further separated into one or more zones within the area. For example, area one may be separated into zone A and zone B. Each zone may be associated with a particular portion of the interior occupied by a passenger. For example, zone A may be associated with a driver; zone B, may be associated with a front passenger. Each zone may include one or more sensors that are positioned or configured to collect information about the environment or ecosystem associated with that zone or person.

As will be appreciated, profiles can be established that allow management of communications within each of the areas, and further optionally within each of the zones. The profile can be granular in nature controlling not only what type of devices can connect within each zone, but how those devices can communicate with other devices and/or the vehicle and types of information that can be communicated.

To assist with identifying a location of a device within a zone, a number of different techniques can be utilized. One optional technique involves one or more of the vehicle sensors detecting the presence of an individual within one of the zones. Upon detection of an individual in a zone, communications subsystems 344 and the access point 456 can cooperate to not only associate the device within the zone with the access point 456 but to also determine the location of the device within an area, and optionally within a zone. Once the device is established within a zone, a profile associated with the vehicle 104 can store information identifying that device and/or a person and optionally associating it with a particular zone as a default. As discussed, there can be a master profile optionally associated with the device in the zone, this master profile can govern communications with the communications subsystems 340 and where communications within vehicle 104 are to occur.

A set of sensors or vehicle components 500 associated with the vehicle 104 may be as shown in FIG. 5A. The vehicle 104 can include, among many other components common to vehicles, wheels 507, a power source 509 (such as an engine, motor, or energy storage system (e.g., battery or capacitive energy storage system)), a manual or automatic transmission 512, a manual or automatic transmission gear controller 516, a power controller 520 (such as a throttle), a vehicle control system 204, the display device 212, a braking system 536, a steering wheel 540, a power source activation/deactivation switch 544 (e.g., an ignition), an occupant seating system 548, a wireless signal receiver 553 to receive wireless signals from signal sources such as roadside beacons and other electronic roadside devices, and a satellite positioning system receiver 557 (e.g., a Global Positioning System (“GPS”) (US), GLONASS (Russia), Galileo positioning system (EU), Compass navigation system (China), and Regional Navigational Satellite System (India) receiver), driverless systems (e.g., cruise control systems, automatic steering systems, automatic braking systems, etc.).

The vehicle 104 can include several sensors in wireless or wired communication with the vehicle control system 204 and/or display device 212, 248 to collect sensed information regarding the vehicle state, configuration, and/or operation. Exemplary sensors may include one or more of, but are not limited to, wheel state sensor 560 to sense one or more of vehicle speed, acceleration, deceleration, wheel rotation, wheel speed (e.g., wheel revolutions-per-minute), wheel slip, and the like, a power source energy output sensor 564 to sense a power output of the power source 509 by measuring one or more of current engine speed (e.g., revolutions-per-minute), energy input and/or output (e.g., voltage, current, fuel consumption, and torque) (e.g., turbine speed sensor, input speed sensor, crankshaft position sensor, manifold absolute pressure sensor, mass flow sensor, and the like), and the like, a switch state sensor 568 to determine a current activation or deactivation state of the power source activation/deactivation switch 544, a transmission setting sensor 570 to determine a current setting of the transmission (e.g., gear selection or setting), a gear controller sensor 572 to determine a current setting of the gear controller 516, a power controller sensor 574 to determine a current setting of the power controller 520, a brake sensor 576 to determine a current state (braking or non-braking) of the braking system 536, a seating system sensor 578 to determine a seat setting and current weight of seated occupant, if any) in a selected seat of the seating system 548, exterior and interior sound receivers 590 and 592 (e.g., a microphone, sonar, and other type of acoustic-to-electric transducer or sensor) to receive and convert sound waves into an equivalent analog or digital signal. Examples of other sensors (not shown) that may be employed include safety system state sensors to determine a current state of a vehicular safety system (e.g., air bag setting (deployed or undeployed) and/or seat belt setting (engaged or not engaged)), light setting sensor (e.g., current headlight, emergency light, brake light, parking light, fog light, interior or passenger compartment light, and/or tail light state (on or off)), brake control (e.g., pedal) setting sensor, accelerator pedal setting or angle sensor, clutch pedal setting sensor, emergency brake pedal setting sensor, door setting (e.g., open, closed, locked or unlocked) sensor, engine temperature sensor, passenger compartment or cabin temperature sensor, window setting (open or closed) sensor, one or more interior-facing or exterior-facing cameras or other imaging sensors (which commonly convert an optical image into an electronic signal but may include other devices for detection objects such as an electromagnetic radiation emitter/receiver that emits electromagnetic radiation and receives electromagnetic waves reflected by the object) to sense objects, such as other vehicles and pedestrians and optionally determine the distance, trajectory and speed of such objects, in the vicinity or path of the vehicle, odometer reading sensor, trip mileage reading sensor, wind speed sensor, radar transmitter/receiver output, brake wear sensor, steering/torque sensor, oxygen sensor, ambient lighting sensor, vision system sensor, ranging sensor, parking sensor, heating, venting, and air conditioning (HVAC) sensor, water sensor, air-fuel ratio meter, blind spot monitor, hall effect sensor, microphone, radio frequency (RF) sensor, infrared (IR) sensor, vehicle control system sensors, wireless network sensor (e.g., Wi-Fi and/or Bluetooth® sensor), cellular data sensor, and other sensors either future-developed or known to those of skill in the vehicle art.

In the depicted vehicle embodiment, the various sensors can be in communication with the display device 212, 248 and vehicle control system 204 via signal carrier network 224. As noted, the signal carrier network 224 can be a network of signal conductors, a wireless network (e.g., a radio frequency, microwave, or infrared communication system using a communications protocol, such as Wi-Fi), or a combination thereof. The vehicle control system 204 may also provide signal processing of one or more sensors, sensor fusion of similar and/or dissimilar sensors, signal smoothing in the case of erroneous “wild point” signals, and/or sensor fault detection. For example, ranging measurements provided by one or more RF sensors may be combined with ranging measurements from one or more IR sensors to determine one fused estimate of vehicle range to an obstacle target.

The control system 204 may receive and read sensor signals, such as wheel and engine speed signals, as a digital input comprising, for example, a pulse width modulated (PWM) signal. The processor 304 can be configured, for example, to read each of the signals into a port configured as a counter or configured to generate an interrupt on receipt of a pulse, such that the processor 304 can determine, for example, the engine speed in revolutions per minute (RPM) and the speed of the vehicle in miles per hour (MPH) and/or kilometers per hour (KPH). One skilled in the art will recognize that the two signals can be received from existing sensors in a vehicle comprising a tachometer and a speedometer, respectively. Alternatively, the current engine speed and vehicle speed can be received in a communication packet as numeric values from a conventional dashboard subsystem comprising a tachometer and a speedometer. The transmission speed sensor signal can be similarly received as a digital input comprising a signal coupled to a counter or interrupt signal of the processor 304 or received as a value in a communication packet on a network or port interface from an existing subsystem of the vehicle 104. The ignition sensor signal can be configured as a digital input, wherein a HIGH value represents that the ignition is on and a LOW value represents that the ignition is OFF. Three bits of the port interface can be configured as a digital input to receive the gear shift position signal, representing eight possible gear shift positions. Alternatively, the gear shift position signal can be received in a communication packet as a numeric value on the port interface. The throttle position signal can be received as an analog input value, typically in the range 0-5 volts. Alternatively, the throttle position signal can be received in a communication packet as a numeric value on the port interface. The output of other sensors can be processed in a similar fashion.

Other sensors may be included and positioned in the interior space 108 of the vehicle 104. Generally, these interior sensors obtain data about the health of the driver and/or passenger(s), data about the safety of the driver and/or passenger(s), and/or data about the comfort of the driver and/or passenger(s). The health data sensors can include sensors in the steering wheel that can measure various health telemetry for the person (e.g., heart rate, temperature, blood pressure, blood presence, blood composition, etc.). Sensors in the seats may also provide for health telemetry (e.g., presence of liquid, weight, weight shifts, etc.). Infrared sensors could detect a person's temperature; optical sensors can determine a person's position and whether the person has become unconscious. Other health sensors are possible and included herein.

Safety sensors can measure whether the person is acting safely. Optical sensors can determine a person's position and focus. If the person stops looking at the road ahead, the optical sensor can detect the lack of focus. Sensors in the seats may detect if a person is leaning forward or may be injured by a seat belt in a collision. Other sensors can detect that the driver has at least one hand on a steering wheel. Other safety sensors are possible and contemplated as if included herein.

Comfort sensors can collect information about a person's comfort. Temperature sensors may detect a temperature of the interior cabin. Moisture sensors can determine a relative humidity. Audio sensors can detect loud sounds or other distractions. Audio sensors may also receive input from a person through voice data. Other comfort sensors are possible and contemplated as if included herein.

FIG. 5B shows an interior sensor configuration for one or more zones of a vehicle 104 optionally. Optionally, the areas and/or zones of a vehicle 104 may include sensors that are configured to collect information associated with the interior 108 of a vehicle 104. In particular, the various sensors may collect environmental information, user information, and safety information, to name a few. Embodiments of these sensors may be as described in conjunction with FIGS. 6A-7B.

Optionally, the sensors may include one or more of optical, or image, sensors 522A-B (e.g., cameras, etc.), motion sensors 524A-B (e.g., utilizing RF, IR, and/or other sound/image sensing, etc.), steering wheel user sensors 542 (e.g., heart rate, temperature, blood pressure, sweat, health, etc.), seat sensors 577 (e.g., weight, load cell, moisture, electrical, force transducer, etc.), safety restraint sensors 579 (e.g., seatbelt, airbag, load cell, force transducer, etc.), interior sound receivers 592A-B, environmental sensors 594 (e.g., temperature, humidity, air, oxygen, etc.), and the like.

The image sensors 522A-B may be used alone or in combination to identify objects, users 216, and/or other features, inside the vehicle 104. Optionally, a first image sensor 522A may be located in a different position within a vehicle 104 from a second image sensor 522B. When used in combination, the image sensors 522A-B may combine captured images to form, among other things, stereo and/or three-dimensional (3D) images. The stereo images can be recorded and/or used to determine depth associated with objects and/or users 216 in a vehicle 104. Optionally, the image sensors 522A-B used in combination may determine the complex geometry associated with identifying characteristics of a user 216. For instance, the image sensors 522A-B may be used to determine dimensions between various features of a user's face (e.g., the depth/distance from a user's nose to a user's cheeks, a linear distance between the center of a user's eyes, and more). These dimensions may be used to verify, record, and even modify characteristics that serve to identify a user 216. As can be appreciated, utilizing stereo images can allow for a user 216 to provide complex gestures in a 3D space of the vehicle 104. These gestures may be interpreted via one or more of the subsystems as disclosed herein. Optionally, the image sensors 522A-B may be used to determine movement associated with objects and/or users 216 within the vehicle 104. It should be appreciated that the number of image sensors used in a vehicle 104 may be increased to provide greater dimensional accuracy and/or views of a detected image in the vehicle 104.

The vehicle 104 may include one or more motion sensors 524A-B. These motion sensors 524A-B may detect motion and/or movement of objects inside the vehicle 104. Optionally, the motion sensors 524A-B may be used alone or in combination to detect movement. For example, a user 216 may be operating a vehicle 104 (e.g., while driving, etc.) when a passenger in the rear of the vehicle 104 unbuckles a safety belt and proceeds to move about the vehicle 104. In this example, the movement of the passenger could be detected by the motion sensors 524A-B. Optionally, the user 216 could be alerted of this movement by one or more of the devices 212, 248 in the vehicle 104. In another example, a passenger may attempt to reach for one of the vehicle control features (e.g., the steering wheel 540, the console, icons displayed on the head unit and/or device 212, 248, etc.). In this case, the movement (i.e., reaching) of the passenger may be detected by the motion sensors 524A-B. Optionally, the path, trajectory, anticipated path, and/or some other direction of movement/motion may be determined using the motion sensors 524A-B. In response to detecting the movement and/or the direction associated with the movement, the passenger may be prevented from interfacing with and/or accessing at least some of the vehicle control features (e.g., the features represented by icons may be hidden from a user interface, the features may be locked from use by the passenger, combinations thereof, etc.). As can be appreciated, the user 216 may be alerted of the movement/motion such that the user 216 can act to prevent the passenger from interfering with the vehicle 104 controls. Optionally, the number of motion sensors in a vehicle 104, or areas of a vehicle 104, may be increased to increase an accuracy associated with motion detected in the vehicle 104.

The interior sound receivers 592A-B may include, but are not limited to, microphones and other types of acoustic-to-electric transducers or sensors. Optionally, the interior sound receivers 592A-B may be configured to receive and convert sound waves into an equivalent analog or digital signal. The interior sound receivers 592A-B may serve to determine one or more locations associated with various sounds in the vehicle 104. The location of the sounds may be determined based on a comparison of volume levels, intensity, and the like, between sounds detected by two or more interior sound receivers 592A-B. For instance, a first interior sound receiver 592A may be located in a first area of the vehicle 104 and a second interior sound receiver 592B may be located in a second area of the vehicle 104. If a sound is detected at a first volume level by the first interior sound receiver 592A and a second, higher, volume level by the second interior sound receiver 592B in the second area of the vehicle 104, the sound may be determined to be closer to the second area of the vehicle 104. As can be appreciated, the number of sound receivers used in a vehicle 104 may be increased (e.g., more than two, etc.) to increase measurement accuracy surrounding sound detection and location, or source, of the sound (e.g., via triangulation, etc.).

Seat sensors 577 may be included in the vehicle 104. The seat sensors 577 may be associated with each seat and/or zone in the vehicle 104. Optionally, the seat sensors 577 may provide health telemetry and/or identification via one or more of load cells, force transducers, weight sensors, moisture detection sensor, electrical conductivity/resistance sensor, and the like. For example, the seat sensors 577 may determine that a user 216 weighs 180 lbs. This value may be compared to user data stored in memory to determine whether a match exists between the detected weight and a user 216 associated with the vehicle 104. In another example, if the seat sensors 577 detect that a user 216 is fidgeting, or moving, in a seemingly uncontrollable manner, the system may determine that the user 216 has suffered a nervous and/or muscular system issue (e.g., seizure, etc.). The vehicle control system 204 may then cause the vehicle 104 to slow down and in addition or alternatively the automobile controller 804 (described below) can safely take control of the vehicle 104 and bring the vehicle 104 to a stop in a safe location (e.g., out of traffic, off a freeway, etc.).

Health telemetry and other data may be collected via the steering wheel user sensors 542. Optionally, the steering wheel user sensors 542 may collect heart rate, temperature, blood pressure, and the like, associated with a user 216 via at least one contact disposed on or about the steering wheel 540.

The safety restraint sensors 579 may be employed to determine a state associated with one or more safety restraint devices in a vehicle 104. The state associated with one or more safety restraint devices may serve to indicate a force observed at the safety restraint device, a state of activity (e.g., retracted, extended, various ranges of extension and/or retraction, deployment, buckled, unbuckled, etc.), damage to the safety restraint device, and more.

Environmental sensors 594, including one or more of temperature, humidity, air, oxygen, carbon monoxide, smoke, and other environmental condition sensors may be used in a vehicle 104. These environmental sensors 594 may be used to collect data relating to the safety, comfort, and/or condition of the interior space 108 of the vehicle 104. Among other things, the data collected by the environmental sensors 594 may be used by the vehicle control system 204 to alter functions of a vehicle. The environment may correspond to an interior space 108 of a vehicle 104 and/or specific areas and/or zones of the vehicle 104. It should be appreciated that an environment may correspond to a user 216. For example, a low oxygen environment may be detected by the environmental sensors 594 and associated with a user 216 who is operating the vehicle 104 in a particular zone. In response to detecting the low oxygen environment, at least one of the subsystems of the vehicle 104, as provided herein, may alter the environment, especially in the particular zone, to increase the amount of oxygen in the zone. Additionally or alternatively, the environmental sensors 594 may be used to report conditions associated with a vehicle (e.g., fire detected, low oxygen, low humidity, high carbon monoxide, etc.). The conditions may be reported to a user 216 and/or a third party via at least one communications module as provided herein.

Among other things, the sensors as disclosed herein may communicate with each other, with devices 212, 248, and/or with the vehicle control system 204 via the signal carrier network 224. Additionally or alternatively, the sensors disclosed herein may serve to provide data relevant to more than one category of sensor information including, but not limited to, combinations of environmental information, user information, and safety information to name a few.

FIGS. 6A-6B show block diagrams of various sensors that may be associated with a vehicle 104. Although depicted as interior and exterior sensors, it should be appreciated that any of the one or more of the sensors shown may be used in both the interior space 108 and the exterior space of the vehicle 104. Moreover, sensors having the same symbol or name may include the same, or substantially the same, functionality as those sensors described elsewhere in the present disclosure. Further, although the various sensors are depicted in conjunction with specific groups (e.g., environmental 608, 608E, user interface 612, safety 616, 616E, etc.) the sensors should not be limited to the groups in which they appear. In other words, the sensors may be associated with other groups or combinations of groups and/or disassociated from one or more of the groups shown. The sensors as disclosed herein may communicate with each other, the devices 212, 248, and/or the vehicle control system 204 via one or more communications channel(s) 356.

FIG. 6A is a block diagram of an embodiment of interior sensors 340 for a vehicle 104 is provided. The interior sensors 340 may be arranged into one or more groups, based at least partially on the function of the interior sensors 340. The interior space 108 of a vehicle 104 may include an environmental group 608, a user interface group 612, and a safety group 616. Additionally or alternatively, there may be sensors associated with various devices inside the vehicle (e.g., devices 212, 248, smart phones, tablets, mobile computers, etc.)

The environmental group 608 may comprise sensors configured to collect data relating to the internal environment of a vehicle 104. In this case, each area and/or zone within a vehicle may include one or more of the environmental sensors. Examples of environmental sensors associated with the environmental group 608 may include, but are not limited to, oxygen/air sensors 624, temperature sensors 628, humidity sensors 632, light/photo sensors 636, and more. The oxygen/air sensors 624 may be configured to detect a quality of the air in the interior space 108 of the vehicle 104 (e.g., ratios and/or types of gasses comprising the air inside the vehicle 104, dangerous gas levels, safe gas levels, etc.). Temperature sensors 628 may be configured to detect temperature readings of one or more objects, users 216, and/or areas of a vehicle 104. Humidity sensors 632 may detect an amount of water vapor present in the air inside the vehicle 104. The light/photo sensors 636 can detect an amount of light present in the vehicle 104. Further, the light/photo sensors 636 may be configured to detect various levels of light intensity associated with light in the vehicle 104.

The user interface group 612 may comprise sensors configured to collect data relating to one or more users 216 in a vehicle 104. As can be appreciated, the user interface group 612 may include sensors that are configured to collect data from users 216 in one or more areas and zones of the vehicle 104. For example, each area and/or zone of the vehicle 104 may include one or more of the sensors in the user interface group 612. Examples of user interface sensors associated with the user interface group 612 may include, but are not limited to, infrared sensors 640, motion sensors 644, weight sensors 648, wireless network sensors 652, biometric sensors 656, camera (or image) sensors 660, audio sensors 664, and more.

Infrared sensors 640 may be used to measure IR light irradiating from at least one surface, user 216, or another object in the vehicle 104. Among other things, the Infrared sensors 640 may be used to measure temperatures, form images (especially in low light conditions), identify users 216, and even detect motion in the vehicle 104.

The motion sensors 644 may be similar to the motion detectors 524A-B, as described in conjunction with FIG. 5B. Weight sensors 648 may be employed to collect data relating to objects and/or users 216 in various areas of the vehicle 104. In some cases, the weight sensors 648 may be included in the seats and/or floor of a vehicle 104.

Optionally, the vehicle 104 may include a wireless network sensor 652. This sensor 652 may be configured to detect one or more wireless network(s) inside the vehicle 104. Examples of wireless networks may include, but are not limited to, wireless communications utilizing Bluetooth®, Wi-Fi™, ZigBee, IEEE 802.11, and other wireless technology standards. For example, a mobile hotspot may be detected inside the vehicle 104 via the wireless network sensor 652. In this case, the vehicle 104 may determine to utilize and/or share the mobile hotspot detected via/with one or more other devices 212, 248 and/or components associated with the vehicle 104.

Biometric sensors 656 may be employed to identify and/or record characteristics associated with a user 216. It is anticipated that biometric sensors 656 can include at least one of image sensors, IR sensors, fingerprint readers, weight sensors, load cells, force transducers, heart rate monitors, blood pressure monitors, and the like as provided herein.

The camera sensors 660 may be similar to image sensors 522A-B, as described in conjunction with FIG. 5B. Optionally, the camera sensors may record still images, video, and/or combinations thereof. The audio sensors 564 may be similar to the interior/exterior sound receivers 592A-B, as described in conjunction with FIGS. 5A-5B. The audio sensors may be configured to receive audio input from a user 216 of the vehicle 104. The audio input from a user 216 may correspond to voice commands, conversations detected in the vehicle 104, phone calls made in the vehicle 104, and/or other audible expressions made in the vehicle 104.

The safety group 616 may comprise sensors configured to collect data relating to the safety of a user 216 and/or one or more components of a vehicle 104. The vehicle 104 may be subdivided into areas and/or zones in an interior space 108 of a vehicle 104 where each area and/or zone may include one or more of the safety sensors provided herein. Examples of safety sensors associated with the safety group 616 may include, but are not limited to, force sensors 668, mechanical motion sensors 672, orientation sensors 676, restraint sensors 680, and more.

The force sensors 668 may include one or more sensors inside the vehicle 104 configured to detect a force observed in the vehicle 104. One example of a force sensor 668 may include a force transducer that converts measured forces (e.g., force, weight, pressure, etc.) into output signals.

Mechanical motion sensors 672 may correspond to encoders, accelerometers, damped masses, and the like. Optionally, the mechanical motion sensors 672 may be adapted to measure the force of gravity (i.e., G-force) as observed inside the vehicle 104. Measuring the G-force observed inside a vehicle 104 can provide valuable information related to a vehicle's acceleration, deceleration, collisions, and/or forces that may have been suffered by one or more users 216 in the vehicle 104. As can be appreciated, the mechanical motion sensors 672 can be located in an interior space 108 or an exterior of the vehicle 104.

Orientation sensors 676 can include accelerometers, gyroscopes, magnetic sensors, and the like that are configured to detect an orientation associated with the vehicle 104. Similar to the mechanical motion sensors 672, the orientation sensors 676 can be located in an interior space 108 or an exterior of the vehicle 104.

The restraint sensors 680 may be similar to the safety restraint sensors 579 as described in conjunction with FIGS. 5A-5B. These sensors 680 may correspond to sensors associated with one or more restraint devices and/or systems in a vehicle 104. Seatbelts and airbags are examples of restraint devices and/or systems. As can be appreciated, the restraint devices and/or systems may be associated with one or more sensors that are configured to detect a state of the device/system. The state may include extension, engagement, retraction, disengagement, deployment, and/or other electrical or mechanical conditions associated with the device/system.

The associated device sensors 620 can include any sensors that are associated with a device 212, 248 in the vehicle 104. As previously stated, typical devices 212, 248 may include smart phones, tablets, laptops, mobile computers, and the like. It is anticipated that the various sensors associated with these devices 212, 248 can be employed by the vehicle control system 204. For example, a typical smart phone can include, an image sensor, an IR sensor, audio sensor, gyroscope, accelerometer, wireless network sensor, fingerprint reader, and more. It is an aspect of the present disclosure that one or more of these associated device sensors 620 may be used by one or more subsystems of the vehicle system 200.

In FIG. 6B, a block diagram of an embodiment of exterior sensors 340 for a vehicle 104 is shown. The exterior sensors may include sensors that are identical, or substantially similar, to those previously disclosed in conjunction with the interior sensors of FIG. 6A. Optionally, the exterior sensors 340 may be configured to collect data relating to one or more conditions, objects, users 216, and other events that are external to the interior space 108 of the vehicle 104. For instance, the oxygen/air sensors 624 may measure a quality and/or composition of the air outside of a vehicle 104. As another example, the motion sensors 644 may detect motion outside of a vehicle 104.

The external environmental group 608E may comprise sensors configured to collect data relating to the external environment of a vehicle 104. In addition to including one or more of the sensors previously described, the external environmental group 608E may include additional sensors, such as, vehicle sensors 650, biological sensors, and wireless signal sensors 658. Vehicle sensors 650 can detect vehicles that are in an environment surrounding the vehicle 104. For example, the vehicle sensors 650 may detect vehicles in a first outside area 516, a second outside area 520, and/or combinations of the first and second outside areas 516, 520. Optionally, the vehicle sensors 650 may include one or more of RF sensors, IR sensors, image sensors, and the like to detect vehicles, people, hazards, etc. that are in an environment exterior to the vehicle 104. Additionally or alternatively, the vehicle sensors 650 can provide distance/directional information relating to a distance (e.g., distance from the vehicle 104 to the detected object) and/or a direction (e.g., direction of travel, etc.) associated with the detected object.

The biological sensors 654 may determine whether one or more biological entities (e.g., an animal, a person, a user 216, etc.) is in an external environment of the vehicle 104. Additionally or alternatively, the biological sensors 654 may provide distance information relating to a distance of the biological entity from the vehicle 104. Biological sensors 654 may include at least one of RF sensors, IR sensors, image sensors and the like that are configured to detect biological entities. For example, an IR sensor may be used to determine that an object, or biological entity, has a specific temperature, temperature pattern, or heat signature. Continuing this example, a comparison of the determined heat signature may be compared to known heat signatures associated with recognized biological entities (e.g., based on shape, locations of temperature, and combinations thereof, etc.) to determine whether the heat signature is associated with a biological entity or an inanimate, or non-biological, object.

The wireless signal sensors 658 may include one or more sensors configured to receive wireless signals from signal sources such as Wi-Fi™ hotspots, cell towers, roadside beacons, other electronic roadside devices, and satellite positioning systems. Optionally, the wireless signal sensors 658 may detect wireless signals from one or more of a mobile phone, mobile computer, keyless entry device, RFID device, near field communications (NFC) device, and the like.

The external safety group 616E may comprise sensors configured to collect data relating to the safety of a user 216 and/or one or more components of a vehicle 104. Examples of safety sensors associated with the external safety group 616E may include, but are not limited to, force sensors 668, mechanical motion sensors 672, orientation sensors 676, vehicle body sensors 682, and more. Optionally, the exterior safety sensors 616E may be configured to collect data relating to one or more conditions, objects, vehicle components, and other events that are external to the vehicle 104. For instance, the force sensors 668 in the external safety group 616E may detect and/or record force information associated with the outside of a vehicle 104. For instance, if an object strikes the exterior of the vehicle 104, the force sensors 668 from the exterior safety group 616E may determine a magnitude, location, and/or time associated with the strike.

The vehicle 104 may include a number of vehicle body sensors 682. The vehicle body sensors 682 may be configured to measure characteristics associated with the body (e.g., body panels, components, chassis, windows, etc.) of a vehicle 104. For example, two vehicle body sensors 682, including a first body sensor and a second body sensor, may be located at some distance apart. Continuing this example, the first body sensor may be configured to send an electrical signal across the body of the vehicle 104 to the second body sensor, or vice versa. Upon receiving the electrical signal from the first body sensor, the second body sensor may record a detected current, voltage, resistance, and/or combinations thereof associated with the received electrical signal. Values (e.g., current, voltage, resistance, etc.) for the sent and received electrical signal may be stored in a memory. These values can be compared to determine whether subsequent electrical signals sent and received between vehicle body sensors 682 deviate from the stored values. When the subsequent signal values deviate from the stored values, the difference may serve to indicate damage and/or loss of a body component. Additionally or alternatively, the deviation may indicate a problem with the vehicle body sensors 682. The vehicle body sensors 682 may communicate with each other, a vehicle control system 204, and/or systems of the vehicle system 200 via a communications channel 356. Although described using electrical signals, it should be appreciated that alternative embodiments of the vehicle body sensors 682 may use sound waves and/or light to perform a similar function.

A representation of a sensor array 692 is shown in FIG. 6C. The sensor array 692, in this example, represents an array of two or more audio sensors 664a, 664b, and/or 664c. Each of the audio sensors 664 can be placed in a different, pre-determined physical location on the vehicle 104. The location and physical arrangement of the audio sensors 664 can be known and allow for triangulation or determination of the location and/or vector of a sound source in the environment 100 of the vehicle 104.

The audio sensors 664 can comprises a microphone 688, an analog to digital converter (ADC) 686, and/or and embedded processor 684. The microphone 688 can receive the audio signal from the audio environment 100. The analog audio signal may then be sent to the ADC 686 to convert the signal into a digital representation of the signal. Metadata describing the digital audio data may also be created by the ADC 686 and sent to the embedded processor 684. A packet of data containing both the digital audio data and/or metadata can be compiled by the embedded processor 684 and sent to the vehicle processor 304 to analyze the audio data. Each sensor 664 can send such data to the processor 304 to allow the processor 304 to determine information about the source of the audio signal based on multiple receptions of the audio signal, as described hereinafter.

FIG. 7A is a block diagram of an embodiment of a media controller subsystem 348 for a vehicle 104. The media controller subsystem 348 may include, but is not limited to, a media controller 704, a media processor 708, a match engine 712, an audio processor 716, a speech synthesis module 720, a network transceiver 724, a signal processing module 728, memory 732, and a language database 736. Optionally, the media controller subsystem 348 may be configured as a dedicated blade that implements the media-related functionality of the system 200. Additionally or alternatively, the media controller subsystem 348 can provide voice input, voice output, library functions for multimedia, and display control for various areas and/or zones of the vehicle 104.

Optionally, the media controller subsystem 348 may include a local IP address (e.g., IPv4, IPv6, combinations thereof, etc.) and even a routable, global unicast address. The routable, global unicast address may allow for direct addressing of the media controller subsystem 348 for streaming data from Internet resources (e.g., cloud storage, user accounts, etc.). It is anticipated, that the media controller subsystem 348 can provide multimedia via at least one Internet connection, or wireless network communications module, associated with the vehicle 104. Moreover, the media controller subsystem 348 may be configured to service multiple independent clients simultaneously.

The media processor 708 may comprise a general purpose programmable processor or controller for executing application programming or instructions related to the media subsystem 348. The media processor 708 may include multiple processor cores, and/or implement multiple virtual processors. Optionally, the media processor 708 may include multiple physical processors. By way of example, the media processor 708 may comprise a specially configured application specific integrated circuit (ASIC) or other integrated circuit, a digital signal processor, a controller, a hardwired electronic or logic circuit, a programmable logic device or gate array, a special purpose computer, or the like. The media processor 708 generally functions to run programming code or instructions implementing various functions of the media controller 704.

The match engine 712 can receive input from one or more components of the vehicle system 700 and perform matching functions. Optionally, the match engine 712 may receive audio input provided via a microphone 786 of the system 700. The audio input may be provided to the media controller subsystem 348 where the audio input can be decoded and matched, via the match engine 712, to one or more functions available to the vehicle 104. Similar matching operations may be performed by the match engine 712 relating to video input received via one or more image sensors, cameras 778, and the like.

The media controller subsystem 348 may include a speech synthesis module 720 configured to provide audio output to one or more speakers 780, or audio output devices, associated with the vehicle 104. Optionally, the speech synthesis module 720 may be configured to provide audio output based at least partially on the matching functions performed by the match engine 712.

As can be appreciated, the coding/decoding, the analysis of audio input/output, and/or other operations associated with the match engine 712 and speech synthesis module 720, may be performed by the media processor 708 and/or a dedicated audio processor 716. The audio processor 716 may comprise a general purpose programmable processor or controller for executing application programming or instructions related to audio processing. Further, the audio processor 716 may be similar to the media processor 708 described herein.

The network transceiver 724 can include any device configured to transmit and receive analog and/or digital signals. Optionally, the media controller subsystem 348 may utilize a network transceiver 724 in one or more communication networks associated with the vehicle 104 to receive and transmit signals via the communications channel 356. Additionally or alternatively, the network transceiver 724 may accept requests from one or more devices 212, 248 to access the media controller subsystem 348. One example of the communication network is a local-area network (LAN). As can be appreciated, the functionality associated with the network transceiver 724 may be built into at least one other component of the vehicle 104 (e.g., a network interface card, communications module, etc.).

The signal processing module 728 may be configured to alter audio/multimedia signals received from one or more input sources (e.g., microphones 786, etc.) via the communications channel 356. Among other things, the signal processing module 728 may alter the signals received electrically, mathematically, combinations thereof, and the like.

The media controller 704 may also include memory 732 for use in connection with the execution of application programming or instructions by the media processor 708, and for the temporary or long term storage of program instructions and/or data. As examples, the memory 732 may comprise RAM, DRAM, SDRAM, or other solid state memory.

The language database 736 may include the data and/or libraries for one or more languages, as are used to provide the language functionality as provided herein. In one case, the language database 736 may be loaded on the media controller 704 at the point of manufacture. Optionally, the language database 736 can be modified, updated, and/or otherwise changed to alter the data stored therein. For instance, additional languages may be supported by adding the language data to the language database 736. In some cases, this addition of languages can be performed via accessing administrative functions on the media controller 704 and loading the new language modules via wired (e.g., USB, etc.) or wireless communication. In some cases, the administrative functions may be available via a vehicle console device 248, a user interface 212, 248, and/or other mobile computing device that is authorized to access administrative functions (e.g., based at least partially on the device's address, identification, etc.).

One or more video controllers 740 may be provided for controlling the video operation of the devices 212, 248, 782 associated with the vehicle 104. Optionally, the video controller 740 may include a display controller for controlling the operation of touch sensitive screens, including input (touch sensing) and output (display) functions. Video data may include data received in a stream and unpacked by a processor and loaded into a display buffer. In this example, the processor and video controller 740 can optimize the display based on the characteristics of a screen of a display device 212, 248, 782. The functions of a touch screen controller may be incorporated into other components, such as a media processor 708 or display subsystem.

The audio controller 744 can provide control of the audio entertainment system (e.g., radio, subscription music service, multimedia entertainment, etc.), and other audio associated with the vehicle 104 (e.g., navigation systems, vehicle comfort systems, convenience systems, etc.). Optionally, the audio controller 744 may be configured to translate digital signals to analog signals and vice versa. As can be appreciated, the audio controller 744 may include device drivers that allow the audio controller 744 to communicate with other components of the system 700 (e.g., processors 716, 708, audio I/O 774, and the like).

The system 700 may include a profile identification module 748 to determine whether a user profile is associated with the vehicle 104. Among other things, the profile identification module 748 may receive requests from a user 216, or device 212, 228, 248, to access a profile stored in a profile database 756 or profile data 252. Additionally or alternatively, the profile identification module 748 may request profile information from a user 216 and/or a device 212, 228, 248, to access a profile stored in a profile database 756 or profile data 252. In any event, the profile identification module 748 may be configured to create, modify, retrieve, and/or store user profiles in the profile database 756 and/or profile data 252. The profile identification module 748 may include rules for profile identification, profile information retrieval, creation, modification, and/or control of components in the system 700.

By way of example, a user 216 may enter the vehicle 104 with a smart phone or other device 212. In response to determining that a user 216 is inside the vehicle 104, the profile identification module 748 may determine that a user profile is associated with the user's smart phone 212. As another example, the system 700 may receive information about a user 216 (e.g., from a camera 778, microphone 786, etc.), and, in response to receiving the user information, the profile identification module 748 may refer to the profile database 756 to determine whether the user information matches a user profile stored in the database 756. It is anticipated that the profile identification module 748 may communicate with the other components of the system to load one or more preferences, settings, and/or conditions based on the user profile. Further, the profile identification module 748 may be configured to control components of the system 700 based on user profile information.

Optionally, data storage 752 may be provided. Like the memory 732, the data storage 752 may comprise a solid-state memory device or devices. Alternatively or in addition, the data storage 752 may comprise a hard disk drive or other random access memory. Similar to the data storage 752, the profile database 756 may comprise a solid-state memory device or devices.

An input/output module 760 and associated ports may be included to support communications over wired networks or links, for example with other communication devices, server devices, and/or peripheral devices. Examples of an input/output module 760 include an Ethernet port, a Universal Serial Bus (USB) port, CAN Bus, Institute of Electrical and Electronics Engineers (IEEE) 1594, or another interface. Users may bring their own devices (e.g., Bring Your Own Device (BYOD), device 212, etc.) into the vehicle 104 for use with the various systems disclosed. Although most BYOD devices can connect to the vehicle systems (e.g., the media controller subsystem 348, etc.) via wireless communications protocols (e.g., Wi-Fi™, Bluetooth®, etc.) many devices may require a direct connection via USB, or similar. In any event, the input/output module 760 can provide the necessary connection of one or more devices to the vehicle systems described herein.

A video input/output interface 764 can be included to receive and transmit video signals between the various components in the system 700. Optionally, the video input/output interface 764 can operate with compressed and uncompressed video signals. The video input/output interface 764 can support high data rates associated with image capture devices. Additionally or alternatively, the video input/output interface 764 may convert analog video signals to digital signals.

The infotainment system 770 may include information media content and/or entertainment content, informational devices, entertainment devices, and the associated programming therefor. Optionally, the infotainment system 770 may be configured to handle the control of one or more components of the system 700 including, but in no way limited to, radio, streaming audio/video devices, audio devices 780, 782, 786, video devices 778, 782, travel devices (e.g., GPS, navigational systems, etc.), wireless communication devices, network devices, and the like. Further, the infotainment system 770 can provide the functionality associated with other infotainment features as provided herein.

An audio input/output interface 774 can be included to provide analog audio to an interconnected speaker 780 or other device, and to receive analog audio input from a connected microphone 786 or another device. As an example, the audio input/output interface 774 may comprise an associated amplifier and analog to digital converter. Alternatively or in addition, the devices 212, 248 can include integrated audio input/output devices 780, 786 and/or an audio jack for interconnecting an external speaker 780 or microphone 786. For example, an integrated speaker 780 and an integrated microphone 786 can be provided, to support near talk, voice commands, spoken information exchange, and/or speaker phone operations.

Among other things, the system 700 may include devices that are part of the vehicle 104 and/or part of a device 212, 248 that is associated with the vehicle 104. For instance, these devices may be configured to capture images, display images, capture sound, and present sound. Optionally, the system 700 may include at least one of image sensors/cameras 778, display devices 782, audio input devices/microphones 786, and audio output devices/speakers 780. The cameras 778 can be included for capturing still and/or video images. Alternatively or in addition, image sensors 778 can include a scanner or code reader. An image sensor/camera 778 can include or be associated with additional elements, such as a flash or other light source. In some cases, the display device 782 may include an audio input device and/or an audio output device in addition to providing video functions. For instance, the display device 782 may be a console, monitor, a tablet computing device, and/or some other mobile computing device.

FIG. 7B is a block diagram of an embodiment of a user/device interaction subsystem 717 in a vehicle system 700. The user/device interaction subsystem 717 may comprise hardware and/or software that conduct various operations for or with the vehicle 104. For instance, the user/device interaction subsystem 717 may include at least one user interaction subsystem 332 and device interaction subsystem 352 as previously described. These operations may include, but are not limited to, providing information to the user 216, receiving input from the user 216, and controlling the functions or operation of the vehicle 104, etc. Among other things, the user/device interaction subsystem 717 may include a computing system operable to conduct the operations as described herein.

Optionally, the user/device interaction subsystem 717 can include one or more of the components and modules provided herein. For instance, the user/device interaction subsystem 717 can include one or more of a video input/output interface 764, an audio input/output interface 774, a sensor module 714, a device interaction module 718, a user identification module 722, a vehicle control module 726, an environmental control module 730, and a gesture control module 734. The user/device interaction subsystem 717 may be in communication with other devices, modules, and components of the system 700 via the communications channel 356.

The user/device interaction subsystem 717 may be configured to receive input from a user 216 and/or device via one or more components of the system. By way of example, a user 216 may provide input to the user/device interaction subsystem 717 via wearable devices 702, 706, 710, video input (e.g., via at least one image sensor/camera 778, etc.) audio input (e.g., via the microphone, audio input source, etc.), gestures (e.g., via at least one image sensor 778, motion sensor 788, etc.), device input (e.g., via a device 212, 248 associated with the user, etc.), combinations thereof, and the like.

The wearable devices 702, 706, 710 can include heart rate monitors, blood pressure monitors, glucose monitors, pedometers, movement sensors, wearable computers, and the like. Examples of wearable computers may be worn by a user 216 and configured to measure user activity, determine energy spent based on the measured activity, track user sleep habits, determine user oxygen levels, monitor heart rate, provide alarm functions, and more. It is anticipated that the wearable devices 702, 706, 710 can communicate with the user/device interaction subsystem 717 via wireless communications channels or direct connection (e.g., where the device docks, or connects, with a USB port or similar interface of the vehicle 104).

A sensor module 714 may be configured to receive and/or interpret input provided by one or more sensors in the vehicle 104. In some cases, the sensors may be associated with one or more user devices (e.g., wearable devices 702, 706, 710, smart phones 212, mobile computing devices 212, 248, and the like). Optionally, the sensors may be associated with the vehicle 104, as described in conjunction with FIGS. 5A-6C.

The device interaction module 718 may communicate with the various devices as provided herein. Optionally, the device interaction module 718 can provide content, information, data, and/or media associated with the various subsystems of the vehicle system 700 to one or more devices 212, 248, 702, 706, 710, 782, etc. Additionally or alternatively, the device interaction module 718 may receive content, information, data, and/or media associated with the various devices provided herein.

The user identification module 722 may be configured to identify a user 216 associated with the vehicle 104. The identification may be based on user profile information that is stored in profile data 252. For instance, the user identification module 722 may receive characteristic information about a user 216 via a device, a camera, and/or some other input. The received characteristics may be compared to data stored in the profile data 252. Where the characteristics match, the user 216 is identified. As can be appreciated, where the characteristics do not match a user profile, the user identification module 722 may communicate with other subsystems in the vehicle 104 to obtain and/or record profile information about the user 216. This information may be stored in a memory and/or the profile data storage 252.

The vehicle control module 726 may be configured to control settings, features, and/or the functionality of a vehicle 104. In some cases, the vehicle control module 726 can communicate with the vehicle control system 204 to control critical functions (e.g., driving system controls, braking, accelerating, etc.) and/or noncritical functions (e.g., driving signals, indicator/hazard lights, mirror controls, window actuation, etc.) based at least partially on user/device input received by the user/device interaction subsystem 717.

The environmental control module 730 may be configured to control settings, features, and/or other conditions associated with the environment, especially the interior environment, of a vehicle 104. Optionally, the environmental control module 730 may communicate with the climate control system (e.g. changing cabin temperatures, fan speeds, air direction, etc.), oxygen and/or air quality control system (e.g., increase/decrease oxygen in the environment, etc.), interior lighting (e.g., changing intensity of lighting, color of lighting, etc.), an occupant seating system 548 (e.g., adjusting seat position, firmness, height, etc.), steering wheel 540 (e.g., position adjustment, etc.), infotainment/entertainment system (e.g., adjust volume levels, display intensity adjustment, change content, etc.), and/or other systems associated with the vehicle environment. Additionally or alternatively, these systems can provide input, set-points, and/or responses, to the environmental control module 730. As can be appreciated, the environmental control module 730 may control the environment based at least partially on user/device input received by the user/device interaction subsystem 717.

The gesture control module 734 is configured to interpret gestures provided by a user 216 in the vehicle 104. Optionally, the gesture control module 734 may provide control signals to one or more of the vehicle systems 300 disclosed herein. For example, a user 216 may provide gestures to control the environment, critical and/or noncritical vehicle functions, the infotainment system, communications, networking, and more. Optionally, gestures may be provided by a user 216 and detected via one or more of the sensors as described in conjunction with FIGS. 5A-7B. As another example, one or more motion sensors 788 may receive gesture input from a user 216 and provide the gesture input to the gesture control module 734. Continuing this example, the gesture input is interpreted by the gesture control module 734. This interpretation may include comparing the gesture input to gestures stored in a memory. The gestures stored in memory may include one or more functions and/or controls mapped to specific gestures. When a match is determined between the detected gesture input and the stored gesture information, the gesture control module 734 can provide a control signal to any of the systems/subsystems as disclosed herein.

FIG. 8 illustrates a GPS/Navigation subsystem(s) 336. The Navigation subsystem(s) 336 can be any present or future-built navigation system that may use location data, for example, from the Global Positioning System (GPS), to provide navigation information or control the vehicle 104. The Navigation subsystem(s) 336 can include several components or modules, such as, one or more of, but not limited to: a GPS Antenna/receiver 820, a location module 828, a maps database 800, an automobile controller 804, a vehicle systems transceiver 808, a traffic controller 812, a network traffic transceiver 816, a traffic information database 824, etc. Generally, the several components or modules 820-824 may be hardware, software, firmware, computer readable media, or combinations thereof.

A GPS Antenna/receiver 820 can be any antenna, GPS puck, and/or receiver capable of receiving signals from a GPS satellite or other navigation system, as mentioned hereinbefore. The signals may be demodulated, converted, interpreted, etc. by the GPS Antenna/receiver 820 and provided to the location module 828. Thus, the GPS Antenna/receiver 820 may convert the time signals from the GPS system and provide a location (e.g., coordinates on a map) to the location module 828. Alternatively, the location module 828 can interpret the time signals into coordinates or other location information.

The location module 828 can be the controller of the satellite navigation system designed for use in automobiles. The location module 828 can acquire position data, as from the GPS Antenna/receiver 820, to locate the user or vehicle 104 on a road in the unit's map database 800. Using the road database 800, the location module 828 can give directions to other locations along roads also in the database 800. When a GPS signal is not available, the location module 828 may apply dead reckoning to estimate distance data from sensors 242 including one or more of, but not limited to, a speed sensor attached to the drive train of the vehicle 104, a gyroscope, an accelerometer, etc. GPS signal loss and/or multipath can occur due to urban canyons, tunnels, and other obstructions. Additionally or alternatively, the location module 828 may use known locations of Wi-Fi hotspots, cell tower data, etc. to determine the position of the vehicle 104, such as by using time difference of arrival (TDOA) and/or frequency difference of arrival (FDOA) techniques.

The maps database 800 can include any hardware and/or software to store information about maps, geographical information system information, location information, etc. The maps database 800 can include any data definition or other structure to store the information. Generally, the maps database 800 can include a road database that may include one or more vector maps of areas of interest. Street names, street numbers, house numbers, and other information can be encoded as geographic coordinates so that the user can find some desired destination by street address. Points of interest (waypoints) can also be stored with their geographic coordinates. For example, a point of interest may include speed cameras, fuel stations, public parking, and “parked here” (or “you parked here”) information. The map database contents can be produced or updated by a server connected through a wireless system in communication with the Internet, even as the vehicle 104 is driven along existing streets, yielding an up-to-date map.

An automobile controller 804 can be any hardware and/or software that can receive instructions from the location module 828 or the traffic controller 812 and operate the vehicle 104. The automobile controller 804 receives this information and data from the sensors 242 to operate the vehicle 104 without driver input. Thus, the automobile controller 804 can drive the vehicle 104 along a route provided by the location module 828. The route may be adjusted by information sent from the traffic controller 812. Discrete and real-time driving can occur with data from the sensors 242. To operate the vehicle 104, the automobile controller 804 can communicate with a vehicle systems transceiver 808.

The vehicle systems transceiver 808 can be any present or future-developed device that can comprise a transmitter and/or a receiver, which may be combined and can share common circuitry or a single housing. The vehicle systems transceiver 808 may communicate or instruct one or more of the vehicle control subsystems 328. For example, the vehicle systems transceiver 808 may send steering commands, as received from the automobile controller 804, to an electronic steering system, to adjust the steering of the vehicle 100 in real time. The automobile controller 804 can determine the effect of the commands based on received sensor data 242 and can adjust the commands as need be. The vehicle systems transceiver 808 can also communicate with the braking system, the engine and drive train to speed or slow the car, the signals (e.g., turn signals and brake lights), the headlights, the windshield wipers, etc. Any of these communications may occur over the components or function as described in conjunction with FIG. 4.

A traffic controller 812 can be any hardware and/or software that can communicate with an automated traffic system and adjust the function of the vehicle 104 based on instructions from the automated traffic system. An automated traffic system is a system that manages the traffic in a given area. This automated traffic system can instruct cars to drive in certain lanes, instruct cars to raise or lower their speed, instruct a car to change their route of travel, instruct cars to communicate with other cars, etc. To perform these functions, the traffic controller 812 may register the vehicle 104 with the automated traffic system and then provide other information including the route of travel. The automated traffic system can return registration information and any required instructions. The communications between the automated traffic system and the traffic controller 812 may be received and sent through a network traffic transceiver 816.

The network traffic transceiver 816 can be any present or future-developed device that can comprise a transmitter and/or a receiver, which may be combined and can share common circuitry or a single housing. The network traffic transceiver 816 may communicate with the automated traffic system using any known or future-developed, protocol, standard, frequency, bandwidth range, etc. The network traffic transceiver 816 enables the sending of information between the traffic controller 812 and the automated traffic system.

The traffic controller 812 can control functions of the automobile controller 804 and communicate with the location module 828. The location module 828 can provide current location information and route information that the traffic controller 812 may then provide to the automated traffic system. The traffic controller 812 may receive route adjustments from the automated traffic system that are then sent to the location module 828 to change the route. Further, the traffic controller 812 can also send driving instructions to the automobile controller 804 to change the driving characteristics of the vehicle 104. For example, the traffic controller 812 can instruct the automobile controller 804 to accelerate or decelerate to a different speed, change lanes, or perform another driving maneuver. The traffic controller 812 can also manage vehicle-to-vehicle communications and store information about the communications or other information in the traffic information database 824.

The traffic information database 824 can be any type of database, such as relational, hierarchical, object-oriented, and/or the like. The traffic information database 824 may reside on a storage medium local to (and/or resident in) the vehicle control system 204 or in the vehicle 104. The traffic information database 824 may be adapted to store, update, and retrieve information about communications with other vehicles or any active instructions from the automated traffic system. This information may be used by the traffic controller 812 to instruct or adjust the performance of driving maneuvers.

As will be appreciated, there could be alternative host devices, such as, host 904 which could also act as, for example, a co-host in association with device 908. Optionally, one or more of the routing profile, permission information, and rules could be shared between the co-host devices 904, 908, both of those devices being usable for Internet access for one or more of the other devices, 912-924. As will be appreciated, the other devices 912-924 need not necessarily connect to one or more of host device 908 and the other device 904 via a direct communications link, but could also interface with those devices 904, 908 utilizing the network /communications buses 224/404 associated with the vehicle 100. As previously discussed, one or more of the other devices can connect to the network/communications buses 224/404 utilizing the various networks and/or buses discussed herein which would therefore enable, for example, regulation of the various communications based on the Ethernet zone that the other device 912 is associated with.

An embodiment of one or more modules that may be associated with the vehicle control system 204 may be as shown in FIG. 9. The modules can include a communication subsystem interface 908 in communication with an operating system 904. The communications may pass through a firewall 944. The firewall 944 can be any software that can control the incoming and outgoing communications by analyzing the data packets and determining whether the packets should be allowed through the firewall, based on applied rule set. A firewall 944 can establish a “barrier” between a trusted, secure internal network and another network (e.g., the Internet) that is not assumed to be secure and trusted.

In some situations, the firewall 944 may establish security zones that are implemented by running system services and/or applications in restricted user groups and accounts. A set of configuration files and callbacks may then be linked to an IP table firewall. The IP table firewall can be configured to notify a custom filter application at any of the layers of the Ethernet packet. The different users/group rights to access the system may include: system users, which may have exclusive right over all device firewall rules and running software; a big-brother user, which may have access to on board device (OBD) control data and may be able to communicate with the vehicle subsystem 328 and may be able to alter the parameters in the vehicle control system 204; a dealer user, which can have rights to read OBD data for diagnostics and repairs; a dashboard user, which can have rights to launch dashboard applications and/or authenticate guest users and change their permissions to trusted/friend/family, and can read but cannot write into OBD diagnostic data; a world wide web (WWW) data user, which can have HTTP rights to respond to HTTP requests (the HTTP requests also can target different user data, but may be filtered by default user accounts); a guest user, which may have no rights; a family/friend user, which may have rights to play media from the media subsystem 348 and/or to stream media to the media subsystem 348.

The operating system 904 can be a collection of software that manages computer hardware resources and provides common services for applications and other programs. The operating system 904 may schedule time-sharing for efficient use of the system. For hardware functions, such as input, output, and memory allocation, the operating system 904 can act as an intermediary between applications or programs and the computer hardware. Examples of operating systems that may be deployed as operating system 904 include Android, BSD, iOS, Linux, OS X, QNX, Microsoft Windows, Windows Phone, IBM z/OS, etc.

The operating system 904 can include one or more sub-modules. For example, a desktop manager 912 can manage one or more graphical user interfaces (GUI) in a desktop environment. Desktop GUIs can help the user to easily access and edit files. A command-line interface (CLI) may be used if full control over the operating system (OS) 904 is required. The desktop manager 912 is described further hereinafter.

A kernel 928 can be a computer program that manages input/output requests from software and translates them into data processing instructions for the processor 304 and other components of the vehicle control system 204. The kernel 928 is the fundamental component of the operating system 904 that can execute many of the functions associated with the OS 904.

The kernel 928 can include other software functions, including, but not limited to, driver(s) 956, communication software 952, and/or Internet Protocol software 948. A driver 956 can be any computer program that operates or controls a particular type of device that is attached to a vehicle control system 204. A driver 956 can communicate with the device through the bus 356 or communications subsystem 908 to which the hardware connects. When a calling program invokes a routine in the driver 956, the driver 956 may issue one or more commands to the device. Once the device sends data back to the driver 956, the driver 956 may invoke routines in the original calling program. Drivers can be hardware-dependent and operating-system-specific. Driver(s) 956 can provide the interrupt handling required for any necessary asynchronous time-dependent hardware interface.

The IP module 948 can conduct any IP addressing, which may include the assignment of IP addresses and associated parameters to host interfaces. The address space may include networks and sub-networks. The IP module 948 can perform the designation of network or routing prefixes and may conduct IP routing, which transports packets across network boundaries. Thus, the IP module 948 may perform all functions required for IP multicast operations.

The communications module 952 may conduct all functions for communicating over other systems or using other protocols not serviced by the IP module 948. Thus, the communications module 952 can manage multicast operations over other busses or networks not serviced by the IP module 948. Further, the communications module 952 may perform or manage communications to one or more devices, systems, data stores, services, etc. that are in communication with the vehicle control system 204 or other subsystems through the firewall 944. Thus, the communications module 952 can conduct communications through the communication subsystem interface 908.

A file system 916 may be any data handling software that can control how data is stored and retrieved. The file system 916 can separate the stored data into individual pieces, and giving each piece a name, can easily separate and identify the pieces of data. Each piece of data may be considered a “file”. The file system 916 can construct data structure and logic rules used to manage the information and the identifiers for the information. The structure and logic rules can be considered a “file system.”

A device discovery daemon 920 may be a computer program that runs as a background process that can discover new devices that connect with the network 356 or communication subsystem 908 or devices that disconnect from the network 356 or communication subsystem 908. The device discovery daemon 920 can ping the network 356 (the local subnet) when the vehicle 104 starts, when a vehicle door opens or closes, or upon the occurrence of other events. Additionally or alternatively, the device discovery daemon 920 may force Bluetooth®, USB, and/or wireless detection. For each device that responds to the ping, the device discovery daemon 920 can populate the system data 208 with device information and capabilities, using any of one or more protocols, including one or more of, but not limited to, IPv6 Hop-by-Hop Option (HOPOPT), Internet Control Message Protocol (ICMP), Internet Group Management Protocol (IGMP), Gateway-to-Gateway Protocol (GGP), Internet Protocol (IP), Internet Stream Protocol (ST), Transmission Control Protocol (TCP), Exterior Gateway Protocol (EGP), CHAOS, User Datagram Protocol (UDP), etc.

For example, the device discovery daemon 920 can determine device capabilities based on the opened ports the device exposes. If a camera exposes port 80, then the device discovery daemon 920 can determine that the camera is using a Hypertext Transfer Protocol (HTTP). Alternatively, if a device is supporting Universal Plug and Play (UPnP), the system data 208 can include more information, for example, a camera control universal resource locator (URL), a camera zoom URL, etc. When a scan stops, the device discovery daemon 920 can trigger a dashboard refresh to ensure the user interface reflects the new devices on the desktop.

A desktop manager 912 may be a computer program that manages the user interface of the vehicle control system 204. The desktop environment may be designed to be customizable and allow the definition of the desktop configuration look-and-feel for a wide range of appliances or devices from computer desktops, mobile devices, computer tablets, etc. Launcher(s), panels, desktop areas, the desktop background, notifications, panes, etc., can be configured from a dashboard configuration file managed by the desktop manager 912. The graphical elements in which the desktop manager 912 controls can include launchers, the desktop, notification bars, etc.

The desktop may be an area of the display where the applications are running. The desktop can have a custom background. Further, the desktop may be divided into two or more areas. For example, the desktop may be divided into an upper half of a display and a lower half of the display. Each application can be configured to run in a portion of the desktop. Extended settings can be added to the desktop configuration file, such that, some objects may be displayed over the whole desktop or in custom size out of the context of the divided areas.

The notification bar may be a part of a bar display system, which may provide notifications by displaying, for example, icons and/or pop-up windows that may be associated with sound notifications. The notification mechanism can be designed for separate plug-ins, which run in separate processes and may subscribe to a system Intelligent Input Bus (IBUS)/D-BUS event service. The icons on the notifications bar can be accompanied with application short-cuts to associated applications, for example, a Bluetooth® manager, a USB manager, radio volume and or tone control, a security firewall, etc.

The desktop manager 912 may include a windows manager 932, an application launcher 936, and/or a panel launcher 940. Each of these components can control a different aspect of the user interface. The desktop manager 912 can use a root window to create panels that can include functionality for one or more of, but not limited to: launching applications, managing applications, providing notifications, etc.

The windows manager 932 may be software that controls the placement and appearance of windows within a graphical user interface presented to the user. Generally, the windows manager 932 can provide the desktop environment used by the vehicle control system 204. The windows manager 932 can communicate with the kernel 928 to interface with the graphical system that provides the user interface(s) and supports the graphics hardware, pointing devices, keyboard, touch-sensitive screens, etc. The windows manager 932 may be a tiling window manager (i.e., a window manager with an organization of the screen into mutually non-overlapping frames, as opposed to a coordinate-based stacking of overlapping objects (windows) that attempts to fully emulate the desktop metaphor). The windows manager 932 may read and store configuration files, in the system data 208, which can control the position of the application windows at precise positions.

An application manager 936 can control the function of any application over the lifetime of the process. The process or application can be launched from a panel launcher 940 or from a remote console. The application manager 936 can intercept the process name and may take appropriate action to manage that process. If the process is not running, the application manager 936 can load the process and may bring the process to a foreground in a display. The application manager 936 may also notify the windows manager 932 to bring the associated window(s) to a top of a window stack for the display. When a process starts from a shell or a notification out of the context of the desktop, the application manager 936 can scan files to match the process name with the entry name provided. When a match is found, the application manager 936 can configure the process according to a settings file.

In some situations, the application manager 936 may restrict an application as singleton (i.e., restricts the instantiation of a class to one object). If an application is already running and the application manager 936 is asked to run the application again, the application manager 936 can bring the running process to a foreground on a display. There can be a notification event exchange between the windows manager 932 and the application manager 936 for activating the appropriate window for the foreground process. Once an application is launched, the application may not be terminated or killed. The application can be sent to the background, except, possibly, for some applications (e.g., media player, Bluetooth®, notifications, etc.), which may be given a lowest process priority.

The panel launcher 940 can be a widget configured to be placed along a portion of the display. The panel launcher 940 may be built from desktop files from a desktop folder. The desktop folder location can be configured by a configuration file stored in system data 208. The panel launcher 940 can allow for the launching or executing of applications or processes by receiving inputs from a user interface to launch programs.

A desktop plugin 924 may be a software component that allows for customization of the desktop or software interface through the initiation of plug-in applications.

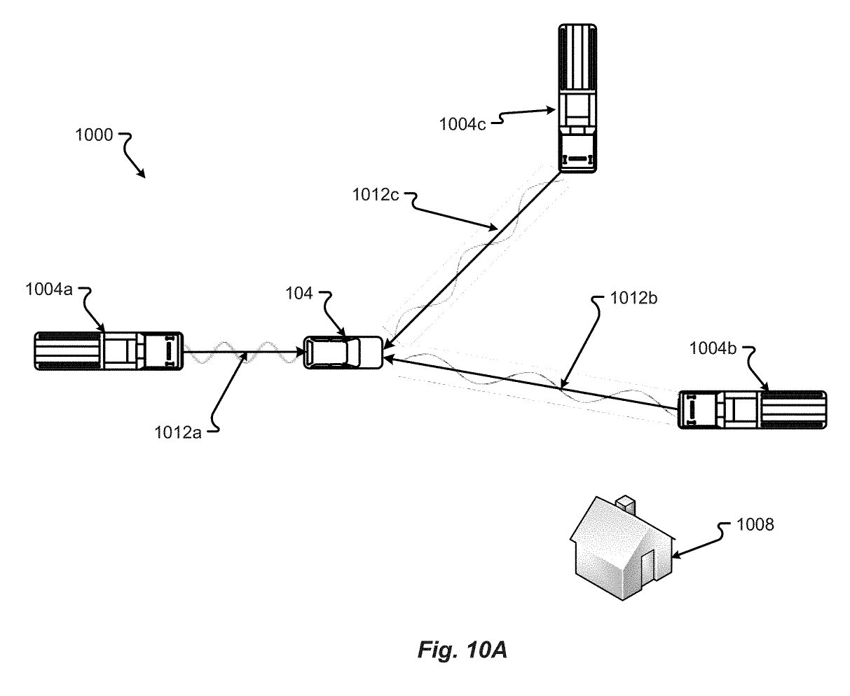

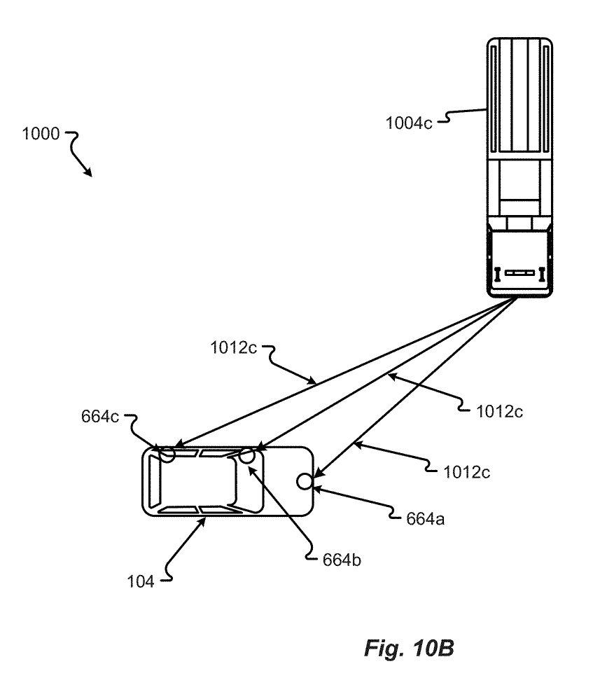

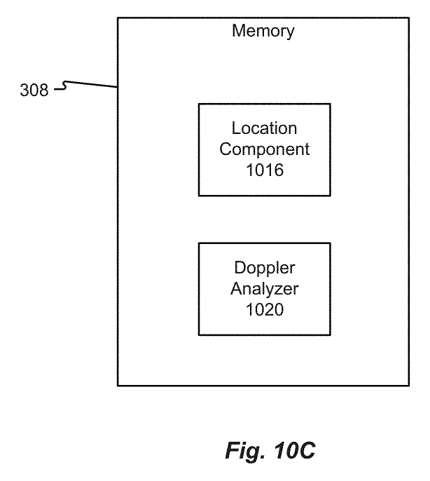

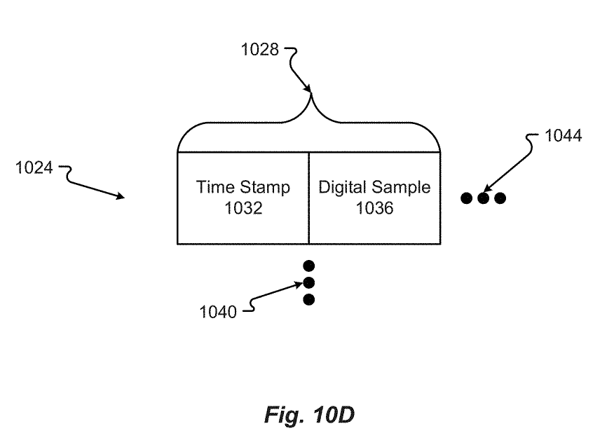

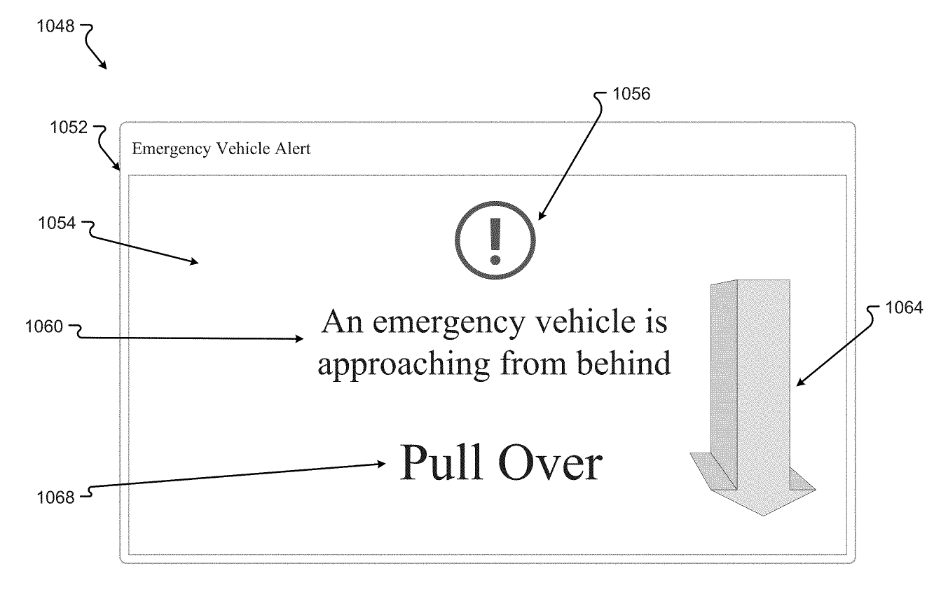

A driving environment 1000 may be represented in FIG. 10A. The environment 1000 can include a vehicle 104 driving a route. Within the environment 1000 may be one or more vehicles 1004a, 1004b, and/or 1004c also traveling along routes, for example, to a location 1008. In an example, the vehicles 1004 are emergency vehicles responding to an emergency at location 1008. The routes of the emergency vehicles 1004 may interfere with route or travel of the vehicle 104 and require the vehicle 104 to yield to the emergency vehicle 1004.

Further, the vehicles 1004 may emanate a sound 1012a, 1012b, and/or 1012c, e.g., a siren sound, to alert other travelers that the emergency vehicle 1004 is near and/or approaching. The sounds 1012 can be received by the vehicle 104. As shown in FIG. 10B, the sound signal 1012c may emanate from emergency vehicle 1004c may reach a sound sensor array 664a, 664b, and/or 664c, where the sensors 664 each receive the signal 1012 (at different times). For example, sensor 664a may receive the sound signal 1012c first followed by sensor 664b and then sensor 664c. Due to the differences in the arrival of the sound signal 1012, the sensors 664 can triangulate or determine a location of the vehicle 1004c. Further, based on changes or characteristics of the received sound signal 1012, the vehicle 104 may determine whether the emergency vehicle 1004 is departing or approaching.

Software and/or hardware components that can analyze the sound environment 1000 may be as shown in FIG. 10C. The components can be part of memory 308, as shown in FIG. 10C, or can be separate components in communication with the processor 304. The components can include one or more of, but is not limited to: a location component 1016 and/or a Doppler analyzer 1020.

A data diagram 1024 representing data provided by sound sensors 664, received and processed by processor 304, and/or stored in memory 308 may be as shown in FIG. 10D. The data 1024 can include one or more samples of a sound signal 1012. A single sample 1028 is shown, but there may be more samples provided by the sounds sensors 664, as represented by ellipses 1044. A sample 1028 is a single digital representation of the analog sound signal 1012 generated based on a clock provided by the processor 304. The clock may be synchronized and adjusted for latency across all the sound sensors 664 to ensure samples 1028 are generated concurrently or simultaneously at each sound sensor 664. As such, each sensor 664 can provide a series of samples 1028. Although only one series of samples 1028 is shown in FIG. 10D, there may be a series of samples 1028 for each sound sensor 664, as represented by ellipses 1040. The periodicity of the samples is variable (e.g., 48 kHz, 96 kHz, etc.) and/or selectable by the manufacturer or user, but a higher the sampling rate of the sound signal 1012 will generate more accurate location determinations.

The samples 1028 can include one or more of, but is not limited to: a time stamp 1032 and a digital sample 1036. The time stamp 1032 represents the time, based on the clock provided by the processor 304, at which the sample 1028 was generated. Each sensor 664 should produce a sample 1028 at the same or substantially the same (e.g., +/−5 picoseconds or less). Thus, each sample 1028, generated at the same time from each sensor 664, should have a same time stamp 1032. The time stamp 1032 can be created by copying the clock time, from the clock provided by the processor 304, into the field 1032.

The digital sample 1036 is a digital representation of the amplitude of the sound signal 1012 at the time represented by the time stamp 1032. The digital representation can be any number of bits, although the greater the number of bits the more accurate the sample. Thus, the digital representation can be a 16-bit representation of the amplitude of the analog sound signal 1012.

Based on the digital representation and time stamps, the processor 304 can determine a time differences in the sound signal 1012 between the different sensors. In other words, the processor 304 can match samples 1028, from different sensors 664, with the same digital representation 1036 of the sound signal 1012. Then, the processor 304 can use the time stamps 1032 of those samples 1028 to determine in what order the sensors 664 received the signal 1012 and the amount of time (based on the difference in the value of the time stamps 1032) between reception of the sound signal 1012 for each sensor 664. As explained below, this time difference information can be used to mathematically calculate a location and direction of travel for the source 1004 of the sound 1012. As the periodic samples 1028 are received over a time period, the accuracy of the location and vector of the sound source 1004 can be improved, and a velocity of travel for the sound source 1004 can be determined by analyzing the change in location over time of the sound source 1004.

A representation of an example user interface 1048 that may be provided on a display 212 for a user 216 of the vehicle 104 may be as shown in FIG. 10E. The user interface 1048 may be provided in a head's-up display 212, on a display 212 in the head unit, on a display 212 in the dash, on a user's mobile device, etc. The user interface 1048 can have a frame 1052 that may provide information about what is displayed, e.g., this user interface is an “Emergency Vehicle Alert.” The frame 1052 can include a display space 1054 that can include other information.

The display space 1054 can include an alert icon 1056 to draw the user's attention. Further, the display space 1054 can include the alert message, e.g., “An emergency vehicle is approaching from behind.” Thus, depending on what information is determined by the processor 304, as explained hereinafter, the user interface 1048 can provide some or all of that information. For example, the information provided can include one or more of, but is not limited to: a direction from which the sound source 1004 is approaching, a direction to which the sound source 1004 is departing, a current, estimated location of the sound source 1004 (which may be provided in a map display provided by the navigation system 336), a determination of whether the vehicle 104 will need to yield or encounter the sound source 1004 on the current path of travel, an amount of time before the vehicle 104 will encounter the sound source 1004, a rate of travel of the sound source 1004, etc.

The display space 1054 can also include other visual information, e.g., the arrow 1064, to provide information about the sound source 1004. In the example shown in FIG. 10E, the arrow 1064 indicates from which direction the sound source 1004 is approaching. This visual information 1064 can provide a quickly understood visual alert to the user 216 without the user 216 needing to read the alert message 1060.

Additionally or alternatively, the display space 1054 can provide a direction or instruction to the user, e.g., “PULL OVER.” The instruction 1068 helps the user 216 understand what response by the user 216 is appropriate for the information provided in the alert 1048. In some configurations, the vehicle control system 204 automatically controls the vehicle 104 to avoid the sound source 1004 and may simply state to the user in information 1068 what action is being taken, e.g., “PULLING OVER.” Other information is possibly provided in user interface 1048 and is therefore contemplated herein. Further, some or all of the information shown in user interface 1048 can be provided by the speakers 780 in an audio alert, e.g., “An emergency vehicle is approaching from behind,” and then, “Pull Over.” Other types of alerts are also possible and contemplated, for example, replicating the sound 1012 (and channeling the sound 1012 to different speakers 780 to replicate from which location the sounds 1012 is emanating) inside the vehicle 104 with speakers 780.

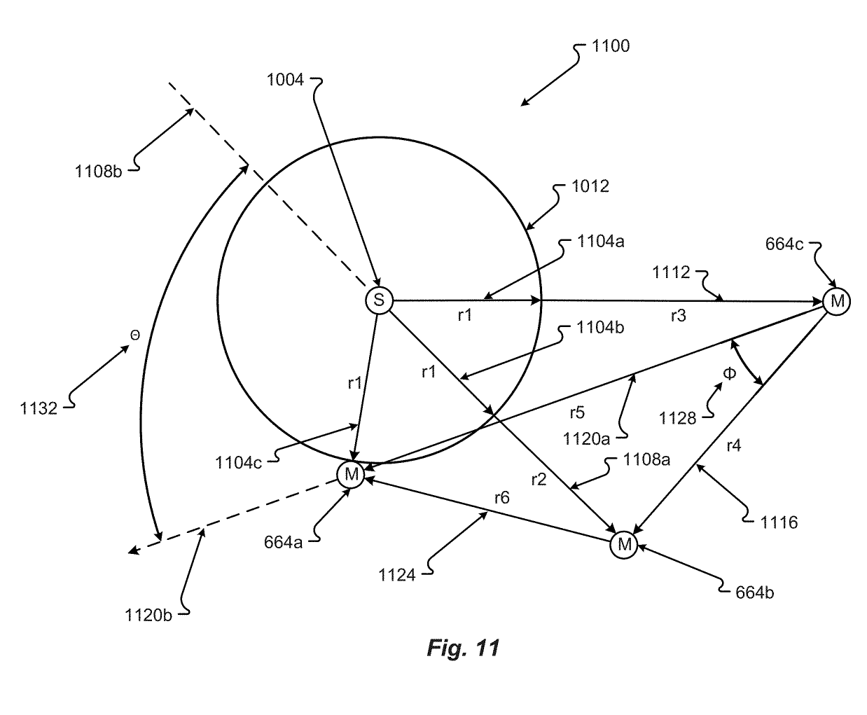

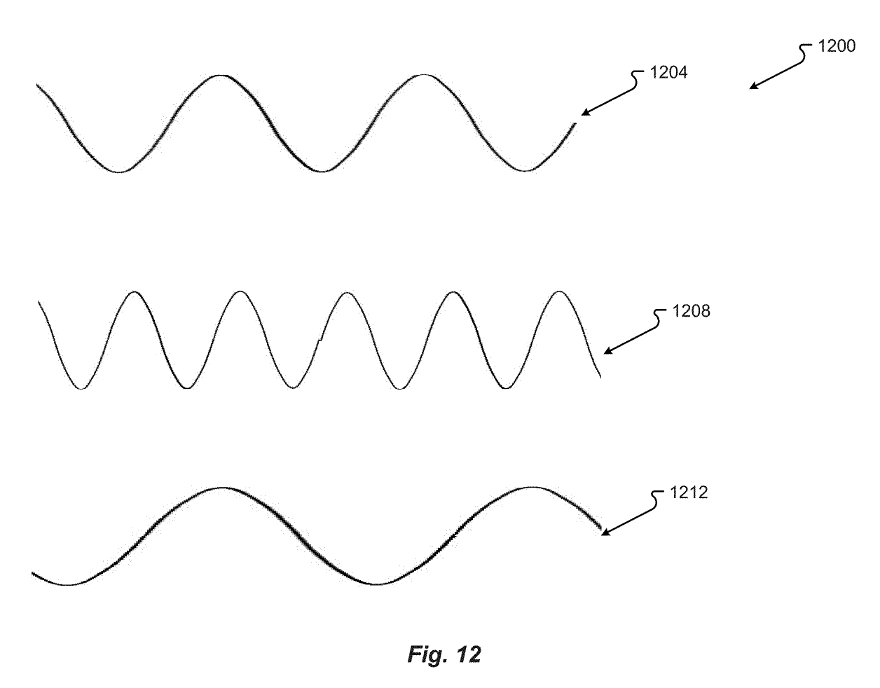

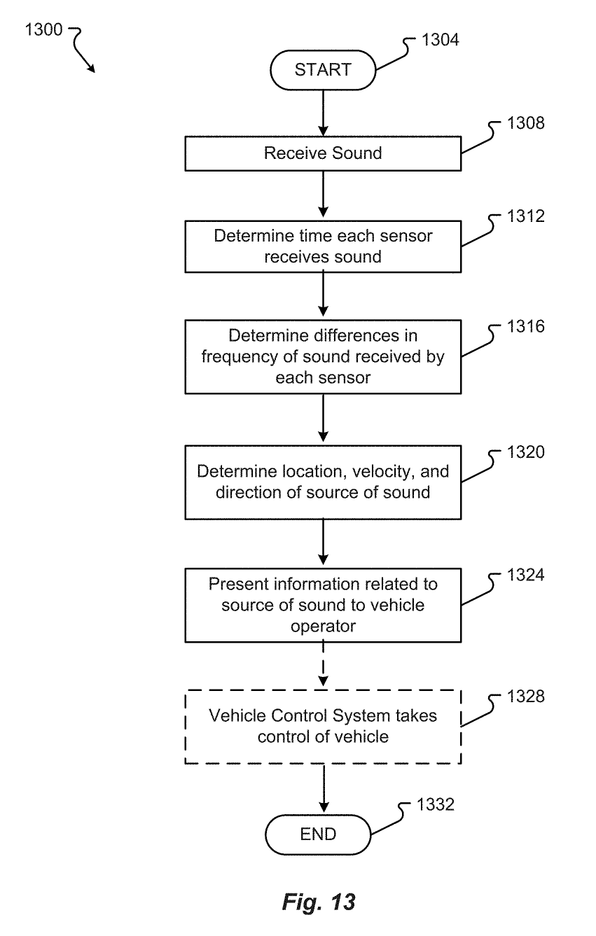

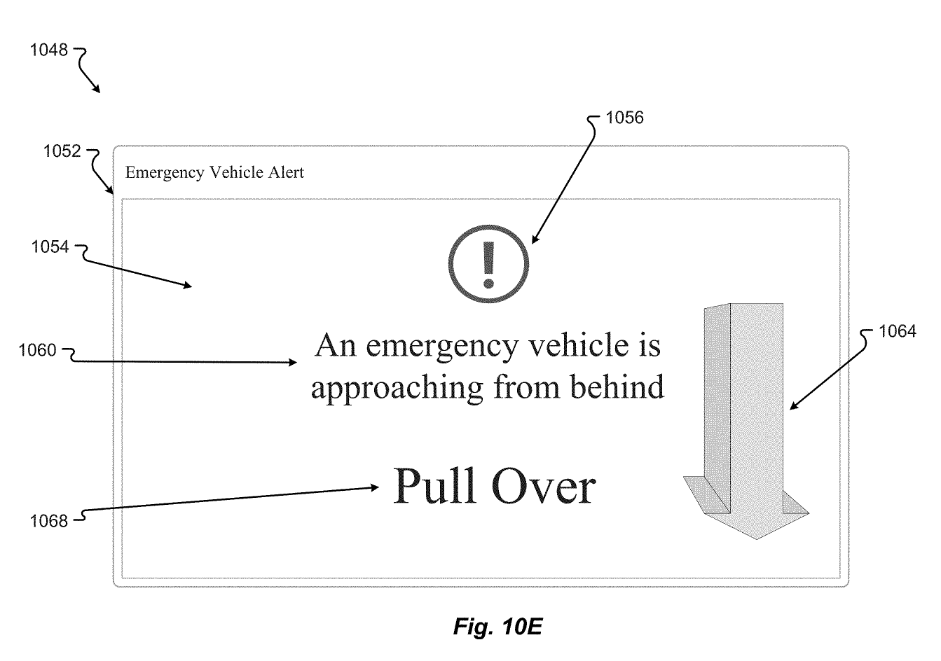

The location component 1016 can receive the various sound signals 1012 from the sensor array 692 comprising sensors 664. From the sound data, the location component 1016 can determine the location of the source 1004 based on analysis of the sound data and/or metadata, as described hereinafter in FIGS. 11 and 13.

The Doppler analyzer 1020 can analyze changes to the signal 1012 based on a source signal to determine if the emergency vehicle 1004 is approaching or departing from the vehicle 104, as described in conjunction with FIG. 12.

A mathematical representation of how the location component 1016 determines the location and/or vector of the sound source 1004 may be as shown in FIG. 11. In some configurations, to determine the location of the source 1004, the location component 1016 must determine a range “r” from two or more sensors having known locations (however, three or more sensors is more accurate and will be explained hereinafter). The source 1004 emanates a sound signal (e.g., a siren, a horn sound, etc.) outwardly, as represented by circle 1012. As the sound signal 1012 emanates outwardly, each sensor 664a, 664b, and/or 664c will receive the signal 1012 at a different time. The difference in the time when the sound signal 1012 is received can determined by a phase shift of the sound signal 1012 as received by the sound sensors 664.

To determine a location, the range “r” from each sounds sensor 664 to the source 1004 can be determine and then triangulation of the location of the source 1004 is possible. It is further possible to determine the direction from which the sound signal 1012 emanated by determining which sensors 664 received the sound signal 1012 first, second, third, etc. A range can be determined by the time the sound signal 1012 travelled multiplied by the speed of sound. To triangulate the sound signal 1012 various locations, ranges, etc. are known or predetermined.

For purposes of explanation, assume that three sound sensors 664a, 664b, 664c have known relative positions. The measurements for determining ranges can be made relative to one of the sensors 664, for example sensor 1 664a, which may receives the sound signal 1012 first. At least some or all of the following information is known based on how the vehicle 104 was manufactured (or an initial survey of the sensor 664 arrangment):
The distance from sensor 1 664a to sensor 3 664c, represented by range r5 1120a;
The distance from sensor 2 664b to sensor 3 664c, represented by range r4 1116;
The angle between sensor 1 664a and sensor 2 664b from the prespective of sensor 3 664c, which may be represented by angle Φ 1128;

The frequency and phase of a clock sent from the CPU 304 to the sensors 664 (this clock may be synchornized between sensors 664 and adjusted for latency to ensure each sensor 664 receives the clock concurrently or simultaneously; the clock provides reference timing to the sensors 664);

Communication between the processor 304 and the sensors 664 can be wireless (e.g., through Bluetooth™, 802.11, etc.) or through a wired connection. Information packets (in the form of digital sound values from the sensors 664 can include a time stamp may be periodically sent from the sensor 664 to the processor 304. The processor 304 can then calculate, with the digital sound data and the time stamps, the location, speed, and direction of a vehicle 1004. In some configurations, the signal processing can be distributed between the sensor 664 and the processor 304 to increase efficiency or accuracy of the system.

There are a number of ways to determine the range and direction of the sound. One way is to apply the law of cosines twice. The Law of cosines is: c²=a²+b²−2ab cos Ø. Applied to the arrangement in FIG. 11, the law of cosines provides the following equations:

(r1+r2)²=(r1+r3)²+r4²−(2*(r1+r3)*r4*Cos Θ)

r1²=(r1+r3)²+r5²−(2*(r1+r3)*r5*Cos(Θ−Φ)

These equations represent a mathematical system 1100 with two unknowns (Θ, r1). This system 1100 of equations, while nonlinear, can be solved using numerical methods. It should be noted that r1 1104a represents the range from the source 1004 to the first sensor 664a, Θ 1132 represents the angle between a known reference line of the vehicle 1120b and the range vector r1, r2 1108b to sensor 2 664b. Further, r2 is the additional range the sound signal 1012 travels after received by sensor 1 664a (r1 1104b) until the sounds signal is received by sensor 2 664b. Simlarly, r3 is the additional range the sound signal 1012 travels after received by sensor 1 664a (r1 1104a) until the sounds signal is received by sensor 3 664c. r5 1120a is the range between sensor 1 664a and sensor 4 664c.

By computing for r1 and Θ 1132, the processor 304 can determine how far the sound source 1004 is from sensor 1 664a and at what angle Θ 1132 the sound source 1004 is to a known reference line 1120 of the vehicle 104. With this information, the location component 1016 of the processor 304 can represent the location of the source 1004 in for a location module 828 in the navigation system 336. Then, the navigation system 336 can show the vehicle 1004 on a map, provide a warning in a heads-up display, duplicate the sound on the interior of the vehicle 104 using the speakers to relicate from where the signal 1012 is emanating, etc.

A representation of how the sound signal 1012 changes based on the Dopler shift may be as shown in FIG. 12. A source signal 1204 may represent the sound signal 1012 in the form it emanated from the source 1004. If the sound source 1004 is approaching the vehicle 104, the Dopler shift of the signal 1012 may create a sounds signal 1208 as received by the sensors 664. In other words, the frequency of the signal increases when the source 1004 approaches the vehicle 104. In contrast, if the source 1004 of the sound signal 1012 is departing from the vehicle 104, the signal 1212 would have a larger frequency than the source signal 1204. The source sound signal(s) 1204 may be stored as system data 208. As such, the processor 304 can make calculations based on comparisons to the source sound signal(s) 1204.

As such, it may be possible to compute the speed of approach or departure of the source 1004 of the sound signal 1012 through signal processing of the doplar shift of the sound and through the rate of change of the shift in frequency. The doppler shift could also be used to estimate the distance of the source 1004 if the fundmental frequency 1204 is known. It would be possible to compute which direction (e.g., behind or in front of) the source 1004 is located and/or if the vehicle 104 is approaching or receding from the source 1004. If needed, a message can then be sent to the vehicle operator (e.g., voice output or display output) to pull over for an approaching emergency vehicle 1004.

FIG. 12 can help represent how sound speed and direction can be calculated through the doppler shift of the source of the sound relative to the sensor 664. Many sound signals 1204, e.g., siren sounds from emergency vehicles, horn sounds of other vehicles, etc., have a unique frequency spectrum signature (provided by a fourier transform); knowning the signature of the sound signal, it may be possible to identify the type of sound source (e.g., fire, police, ambulance, Ford truck, Subaru Outback, etc.). It may also be possible to identify other sound sources, for example, a gun shot or human voice. To determine information based on the sound signal, the following information is known:
Fₛ is the emitted frequency 1204 from the source 1004 (the transmitter);
Fᵣ is the frequency 1208, 1212 observed by the observer 664 (the receiver);
Vs is the velocity of the source 1004 relative to the medium, which may be determined from equations below;
Vr is the velocity of the receiver 104 relative to the medium, as provided by the vehicle control system 204;
C is the velocity of the signal in the medium (e.g., the speed of sound).

Using the above known information, the following equations can be used to determine the velocity of the sound source 1004 relative to the receiver 664:

$${F}_{r} = ( ( C + Vr ) / ( C + Vs ) * {F}_{S} \\ Δ v = Vr - Vs \\ {F}_{r} = ( 1 + \frac{Δ v}{C} ) * {F}_{S} \\ Δ v = ( \frac{{F}_{r}}{{F}_{S}} - 1 ) * C$$

Since the velocity of the receiver Vr is known and the frequency 1204 of the source 1004 can be estimated (e.g., estimated from a list of known frequency spectrum (signatures) for local vehicles in system data 208) then the following calculates the speed of the source 1004:

$$Vs = Vr - ( \frac{{F}_{r}}{{F}_{S}} - 1 )$$

The sign of the Vs indicates whether the source is approaching or receding. Further, the following equation calculates whether the source 1004 is approaching or receding:

Δf=F_{R}−Fₛ

An embodiment of a method 1300 for identifying a source 1004 of a sound 1012 and determining the location and the velocity of the source 1004 of the sound 1012 may be as shown in FIG. 13. Generally, the method 1300 starts with a start operation 1304 and ends with operation 1332. The method 1300 can include more or fewer steps or can arrange the order of the steps differently than those shown in FIG. 13. The method 1300 can be executed as a set of computer-executable instructions executed by a computer system or processor and encoded or stored on a computer readable medium. In other configurations, the method 1300 may be executed by a series of components, circuits, gates, etc. created in a hardware device, such as a System of Chip (SOC), Application Specific Integrated Circuit (ASIC), and/r a Field Programmable Gate Array (FPGA). Hereinafter, the method 1300 shall be explained with reference to the systems, components, circuits, modules, software, data structures, signaling processes, models, environments, vehicles, etc. described in conjunction with FIGS. 1-12.

A sensor(s) 664 can receive a sound signal 1012 from a sound source 1004, in step 1308. The vehicle 104 may include any type and variety of sensors 664 operable to receive sound, as described in conjunction with FIGS. 6B and 6C. The sensors 664 may be positioned in various locations around the vehicle 1004, including within the interior 108 of the vehicle 104 and on an exterior of the vehicle 104, as described in conjunction with FIGS. 5A-6C.

As each sensor 664 receives the sound signal 1012, the sensor 664 transmits information about the sound signal 1012, as received, to the processor 304 of the vehicle control system 204. The information sent to the processor 304 can include a digital representation of a sample of the sound signal 1012 and a time stamp representing the time (provided by a clock sent from the processor 304 to the sensor 664) at which the signal was sampled. The processor 304 receives the information from the sensor 664 to determine the time each sensor 664a, 664b, and/or 664c receives the sound signal 1012, in step 1312. The information may comprise information such as, but not limited to, a frequency of the sound, the time the sound was received, and the intensity of the sound in decibels, etc. The sensor 664 may send the information to the vehicle control system 204 over a wired or wireless connection.

The processor 304 of the vehicle control system 204 can receive information related to a sound signal 1012 received from the sensors 664 and compares the information received from the different sensors 664 to determine differences in frequency or timing of the received signal 1012, in step 1316. The processor 304 of the vehicle control system 204 can determine differences in times that each sensor 664 received the sound signal 1012.

The different times of arrival of the sound signal 1012, at each sensor 664, may be used to determine the relative location of the source 1004 of the sound signal 1012 compared to the location of the vehicle 104, in step 1320. The processor 304 of the vehicle control system 204 can use the calculations described in conjunction with FIGS. 10A through 12 to determine a location, velocity, direction, etc., of the source 1004 of the sound signal 1012. Optionally, the vehicle control system 204 may compare information related to the sound signal 1012 to a database 208 of sounds to determine a vehicle type of the source 1004. The vehicle type may be, but is not limited to, an emergency vehicle (e.g., fire, medical, police, military), non-emergency vehicle (e.g., private passenger car, commercial passenger bus, commercial transport truck, etc.), etc. The vehicle control system 204 may also determine a manufacturer of the vehicle 1004 by analyzing the sounds received from one or more of a siren of the vehicle 1004 and/or the vehicle horn.

The vehicle control system 204 may then present information related to the source 1004 of the sound signal 1012 to an operator of the vehicle 104, in step 1324. The information may include information such as one or more of, but not limited to: the location of the sound source 1004, the velocity of the sound source 1004, the type of the vehicle 1004 that produced the sound, etc. The information may be presented on a user interface, such as a dash display 212 or a head's-up display, of the vehicle 104. Optionally, the information may include an audible alert produced by the vehicle control system 204. For example, the vehicle control system 204 can output a voice synthetization to the speakers 780 that states, for example: “An emergency vehicle is approaching from the rear.”

Additionally or alternatively, the vehicle control system 204 can automatically control functions, for example, the braking system to slow the vehicle 104, throttle functions to accelerate or decelerate the vehicle 104, the steering system to move the vehicle 104, in step 1328. The vehicle control system 204 may activate the automobile controller 804 (described in conjunction with FIG. 8) to take control of the vehicle 104 and move the vehicle 104 from the path of the vehicle 1004. Thus, the VCS 204 and/or controller 804 may take control of the vehicle 104 to avoid, or make room for, an emergency vehicle 1004.

Presented herein are embodiments of systems, devices, processes, data structures, user interfaces, etc. The embodiments may relate to an automobile and/or an automobile environment. The automobile environment can include systems associated with the automobile and devices or other systems in communication with the automobile and/or automobile systems. Furthermore, the systems can relate to communications systems and/or devices and may be capable of communicating with other devices and/or to an individual or group of individuals. Further, the systems can receive user input in unique ways. The overall design and functionality of the systems provide for an enhanced user experience making the automobile more useful and more efficient. As described herein, the automobile systems may be electrical, mechanical, electro-mechanical, software-based, and/or combinations thereof.

The exemplary systems and methods of this disclosure have been described in relation to configurable vehicle consoles and associated devices. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide some features of the disclosure without providing others. It is another aspect of the present disclosure to provide a vehicle control system 204 that can determine a type and a manufacturer of a second vehicle 1004 based on sounds received by vehicle sensors 664. Accordingly, the vehicle control system 204 can determine that the second vehicle 1004 is, for example: an ambulance, a police car, a fire vehicle based on the frequency of sound received by the sensors 664. Additionally or alternatively, the vehicle control system 204 can identify a manufacturer, for example, but not limited to: Ford, Chrysler, GM, Toyota, etc., of the second vehicle 1004 based on a sound 1012 originating from a horn associated with the second vehicle 1004. In still other situation, the vehicle control system 204 can identify a model of the second vehicle 1004 based on the sound received from the horn of the second vehicle 1004.

In some situations, a method of determining the source of a sound comprises determining a type of a vehicle as the source of the sound. The type of vehicle may be identified by analyzing the sound and comparing the received sound to known sounds produced by sirens and/or vehicle horns. The manufacturer of the vehicle may also be determined based on the sound of the vehicle horn. The known sounds may be retrieved from a database of sounds. In other circumstances, the method further comprises determining the source of the sound is a weapon, for example, a gunshot or a human voice. If the source of the sound is a weapon, the method may further comprise providing a warning to the vehicle operator or taking evasive action.

The system and method of the present disclosure could be added to an existing automobile or integrated into the automobile's navigation system. Additionally or alternatively, the system and method of the present disclosure could also be used in a self-driving vehicle for emergency vehicle avoidance.

It should be appreciated that the various processing modules (e.g., processors, vehicle systems, vehicle subsystems, modules, etc.), for example, can perform, monitor, and/or control critical and non-critical tasks, functions, and operations, such as interaction with and/or monitoring and/or control of critical and non-critical on board sensors and vehicle operations (e.g., engine, transmission, throttle, brake power assist/brake lock-up, electronic suspension, traction and stability control, parallel parking assistance, occupant protection systems, power steering assistance, self-diagnostics, event data recorders, steer-by-wire and/or brake-by-wire operations, vehicle-to-vehicle interactions, vehicle-to-infrastructure interactions, partial and/or full automation, telematics, navigation/SPS, multimedia systems, audio systems, rear seat entertainment systems, game consoles, tuners (SDR), heads-up display, night vision, lane departure warning, adaptive cruise control, adaptive headlights, collision warning, blind spot sensors, park/reverse assistance, tire pressure monitoring, traffic signal recognition, vehicle tracking (e.g., LoJack™), dashboard/instrument cluster, lights, seats, climate control, voice recognition, remote keyless entry, security alarm systems, and wiper/window control). Processing modules can be enclosed in an advanced EMI-shielded enclosure containing multiple expansion modules. Processing modules can have a “black box” or flight data recorder technology, containing an event (or driving history) recorder (containing operational information collected from vehicle on board sensors and provided by nearby or roadside signal transmitters), a crash survivable memory unit, an integrated controller and circuitry board, and network interfaces.

Critical system controller(s) can control, monitor, and/or operate critical systems. Critical systems may include one or more of (depending on the particular vehicle) monitoring, controlling, operating the ECU, TCU, door settings, window settings, blind spot monitor, monitoring, controlling, operating the safety equipment (e.g., airbag deployment control unit, collision sensor, nearby object sensing system, seat belt control unit, sensors for setting the seat belt, etc.), monitoring and/or controlling certain critical sensors such as the power source controller and energy output sensor, engine temperature, oil pressure sensing, hydraulic pressure sensors, sensors for headlight and other lights (e.g., emergency light, brake light, parking light, fog light, interior or passenger compartment light, and/or tail light state (on or off)), vehicle control system sensors, wireless network sensor (e.g., Wi-Fi and/or Bluetooth sensors, etc.), cellular data sensor, and/or steering/torque sensor, controlling the operation of the engine (e.g., ignition, etc.), head light control unit, power steering, display panel, switch state control unit, power control unit, and/or brake control unit, and/or issuing alerts to a user and/or remote monitoring entity of potential problems with a vehicle operation.

Non-critical system controller(s) can control, monitor, and/or operate non-critical systems. Non-critical systems may include one or more of (depending on the particular vehicle) monitoring, controlling, operating a non-critical system, emissions control, seating system controller and sensor, infotainment/entertainment system, monitoring certain non-critical sensors such as ambient (outdoor) weather readings (e.g., temperature, precipitation, wind speed, and the like), odometer reading sensor, trip mileage reading sensor, road condition sensors (e.g., wet, icy, etc.), radar transmitter/receiver output, brake wear sensor, oxygen sensor, ambient lighting sensor, vision system sensor, ranging sensor, parking sensor, heating, venting, and air conditioning (HVAC) system and sensor, water sensor, air-fuel ratio meter, hall effect sensor, microphone, radio frequency (RF) sensor, and/or infrared (IR) sensor.

It is an aspect of the present disclosure that one or more of the non-critical components and/or systems provided herein may become critical components and/or systems, and/or vice versa, depending on a context associated with the vehicle.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processor 304, as described herein, may include, but are not limited to: at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3560K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

Aspects of the embodiments can include:

A method for providing information about a sound source in a vehicle, the method comprising: receiving a sound signal at a sensor array; based on the sound signal, a vehicle control system determining a location of the sound source; the vehicle control system determining a direction of travel for the sound source; and the vehicle control system alerting a user in the vehicle about the sound source.

Any of the one or more above aspects, wherein the sensor array includes three or more sensors positioned in different physical locations about the vehicle, wherein the physical locations are predetermined and known, and wherein each physical location of a sensor relative to the physical location of at least one other sensor is predetermined and known.

Any of the one or more above aspects, wherein the three or more sensors are sound sensors.

Any of the one or more above aspects, wherein the three or more sensors include a microphone, an analog-to-digital converter, and an embedded processor.

Any of the one or more above aspects, wherein the three or more sensors provide a digital representation of the sound signal and a time stamp for a sample of the sound signal to a processor of the vehicle control system.

Any of the one or more above aspects, wherein, based on the digital representation and the time stamp of the sound signal received from each of the three or more sensors, the processor determines a time difference of when each of the three or more sensors received the sound signal.

Any of the one or more above aspects, wherein, based on the time difference, the processor determines the location of the sound source by applying the law of cosines twice.

Any of the one or more above aspects, wherein the processor determines a velocity and direction of travel for the sound source based on a Doppler shift of the sound signal.

Any of the one or more above aspects, wherein the processor compares the received sound signal to a source sound signal stored in a memory in the vehicle to determine a vehicle type for the source of the sound signal.

Any of the one or more above aspects, wherein the vehicle type is an emergency vehicle.

Any of the one or more above aspects, wherein alerting the user includes presenting a display in the vehicle that provides an indication where the emergency vehicle is and an action for the user to take to avoid the emergency vehicle.

Any of the one or more above aspects, wherein alerting the user includes the vehicle control system automatically controls the vehicle to avoid the emergency vehicle.

A vehicle comprising: a sensor array comprising three or more sound sensors to receive a sound signal from a sound source; a vehicle control system in communication with the sensor array, the vehicle control system comprising: a memory to store information about sources of sounds; a processor in communication with the memory, the processor to: determine a location of the sound source; determine a direction of travel for the sound source; determine if the sound source is approaching the vehicle; determine if the vehicle needs to avoid the sound source; and if the sound source is approaching the vehicle and if the vehicle needs to avoid the sound source, alert a user in the vehicle about the sound source.

Any of the one or more above aspects, wherein the three or more sensors are positioned in different physical locations about the exterior of the vehicle, wherein each physical location of a sensor relative to the physical location of at least one other sensor is predetermined and known, wherein the three or more sensors include a microphone, an analog-to-digital converter, and an embedded processor, and wherein the three or more sensors periodically sample the sound signal and periodically provide a digital representation of the sound signal and a time stamp for a sample of the sound signal to a processor of the vehicle control system.

Any of the one or more above aspects, wherein, to determine the location and based on the digital representation and the time stamp of the sound signal received from each of the three or more sensors, the processor determines a time difference of when each of the three or more sensors received the sound signal, and wherein, based on the time difference, the processor determines the location of the sound source by applying the law of cosines twice.

Any of the one or more above aspects, wherein the processor determines a velocity and direction of travel for the source based on a Doppler shift of the sound signal.

Any of the one or more above aspects, wherein the processor compares the received sound signal to a source sound signal stored in a memory in the vehicle to determine a vehicle type for the source of the sound signal, wherein the vehicle type is an emergency vehicle, and wherein alerting the user includes presenting a display in the vehicle that provides an indication where the emergency vehicle is and an action for the user to take to avoid the emergency vehicle.

A non-transitory computer readable media having stored thereon instructions, which when executed by a processor of a vehicle control system, cause the processor to perform a method comprising: receiving three samples of a sound signal, emanating from a source of the sound signal, from a sensor array comprising three or more sound sensors; based on the three samples, determining a location of the sound source; based on the three samples, determining if the sound source is approaching the vehicle; determining if the vehicle needs to avoid the sound source; and if the sound source is approaching the vehicle and if the vehicle needs to avoid the sound source, alerting a user in the vehicle about the sound source.

Any of the one or more above aspects, wherein the three or more sensors are positioned in different physical locations about the exterior of the vehicle, wherein each physical location of a sensor relative to the physical location of at least one other sensor is predetermined and known, wherein the three or more sensors include a microphone, an analog-to-digital converter, and an embedded processor, and wherein the three or more sensors periodically sample the sound signal and periodically provide a digital representation of the sound signal and a time stamp for a sample of the sound signal to a processor of the vehicle control system.

Any of the one or more above aspects, wherein, to determine the location and based on the digital representation and the time stamp of the sound signal received from each of the three or more sensors, the processor determines a time difference of when each of the three or more sensors received the sound signal, and wherein, based on the time difference, the processor determines the location of the sound source by applying the law of cosines twice, and wherein the processor determines a velocity and direction of travel for the source based on a Doppler shift of the sound signal.

Any of the one or more above aspects, wherein the processor compares the received sound signal to a source sound signal stored in a memory in the vehicle to determine a vehicle type for the source of the sound signal, wherein the vehicle type is an emergency vehicle, and wherein alerting the user includes presenting a display in the vehicle that provides an indication where the emergency vehicle is and an action for the user to take to avoid the emergency vehicle.

The above aspects have various advantages. First, users with diminished hearing can be provided visual information about sounds sources, for example, the location and possibility of encountering an emergency vehicle based on siren sound information. Second, distracted users, who are possibly listening to loud music, can be give similar sound source information above. Also, determining a location of a sound source, for example, determining from where a siren sound is emanating, can sometimes be difficult due to the driving environment. In these situations, the vehicle control system provides the user with easily understood location information that eliminates the user's need to scan the entire surrounding to location the source of the sound. Other advantages are also possible such as automatically avoiding gunfire, an emergency vehicle, a honking car, etc. by locating the sound source and automatically controlling the vehicle to avoid these sources of sound.

What is claimed is:

1. A method for providing information about a sound source in a vehicle, the method comprising:
receiving a sound signal at a sensor array;
based on the sound signal, a vehicle control system determining a location of the sound source;
the vehicle control system determining a direction of travel for the sound source; and
the vehicle control system alerting a user in the vehicle about the sound source.

2. The method of claim 1, wherein the sensor array includes three or more sensors positioned in different physical locations about the vehicle, wherein the physical locations are predetermined and known, and wherein each physical location of a sensor relative to the physical location of at least one other sensor is predetermined and known.

3. The method of claim 2, wherein the three or more sensors are sound sensors.

4. The method of claim 3, wherein the three or more sensors include a microphone, an analog-to-digital converter, and an embedded processor.

5. The method of claim 4, wherein the three or more sensors provide a digital representation of the sound signal and a time stamp for a sample of the sound signal to a processor of the vehicle control system.

6. The method of claim 5, wherein, based on the digital representation and the time stamp of the sound signal received from each of the three or more sensors, the processor determines a time difference of when each of the three or more sensors received the sound signal.

7. The method of claim 6, wherein, based on the time difference, the processor determines the location of the sound source by applying the law of cosines twice.

8. The method of claim 7, wherein the processor determines a velocity and direction of travel for the sound source based on a Doppler shift of the sound signal.

9. The method of claim 8, wherein the processor compares the received sound signal to a source sound signal stored in a memory in the vehicle to determine a vehicle type for the source of the sound signal.

10. The method of claim 9, wherein the vehicle type is an emergency vehicle.

11. The method of claim 10, wherein alerting the user includes presenting a display in the vehicle that provides an indication where the emergency vehicle is and an action for the user to take to avoid the emergency vehicle.

12. The method of claim 10, wherein alerting the user includes the vehicle control system automatically controls the vehicle to avoid the emergency vehicle.

13. A vehicle comprising:
a sensor array comprising three or more sound sensors to receive a sound signal from a sound source;
a vehicle control system in communication with the sensor array, the vehicle control system comprising:
a memory to store information about sources of sounds;
a processor in communication with the memory, the processor to:
determine a location of the sound source;
determine a direction of travel for the sound source;
determine if the sound source is approaching the vehicle;
determine if the vehicle needs to avoid the sound source; and
if the sound source is approaching the vehicle and if the vehicle needs to avoid the sound source, alert a user in the vehicle about the sound source.

14. The vehicle of claim 13, wherein the three or more sensors are positioned in different physical locations about the exterior of the vehicle, wherein each physical location of a sensor relative to the physical location of at least one other sensor is predetermined and known, wherein the three or more sensors include a microphone, an analog-to-digital converter, and an embedded processor, and wherein the three or more sensors periodically sample the sound signal and periodically provide a digital representation of the sound signal and a time stamp for a sample of the sound signal to a processor of the vehicle control system.

15. The vehicle of claim 14, wherein, to determine the location and based on the digital representation and the time stamp of the sound signal received from each of the three or more sensors, the processor determines a time difference of when each of the three or more sensors received the sound signal, and wherein, based on the time difference, the processor determines the location of the sound source by applying the law of cosines twice.

16. The vehicle of claim 15, wherein the processor determines a velocity and direction of travel for the source based on a Doppler shift of the sound signal.

17. The vehicle of claim 16, wherein the processor compares the received sound signal to a source sound signal stored in a memory in the vehicle to determine a vehicle type for the source of the sound signal, wherein the vehicle type is an emergency vehicle, and wherein alerting the user includes presenting a display in the vehicle that provides an indication where the emergency vehicle is and an action for the user to take to avoid the emergency vehicle.

18. A non-transitory computer readable media having stored thereon instructions, which when executed by a processor of a vehicle control system, cause the processor to perform a method comprising:
receiving three samples of a sound signal, emanating from a source of the sound signal, from a sensor array comprising three or more sound sensors;
based on the three samples, determining a location of the sound source;
based on the three samples, determining if the sound source is approaching the vehicle;
determining if the vehicle needs to avoid the sound source; and
if the sound source is approaching the vehicle and if the vehicle needs to avoid the sound source, alerting a user in the vehicle about the sound source.

19. The non-transitory computer readable media of claim 17, wherein the three or more sensors are positioned in different physical locations about the exterior of the vehicle, wherein each physical location of a sensor relative to the physical location of at least one other sensor is predetermined and known, wherein the three or more sensors include a microphone, an analog-to-digital converter, and an embedded processor, and wherein the three or more sensors periodically sample the sound signal and periodically provide a digital representation of the sound signal and a time stamp for a sample of the sound signal to a processor of the vehicle control system.

20. The non-transitory computer readable media of claim 18, wherein, to determine the location and based on the digital representation and the time stamp of the sound signal received from each of the three or more sensors, the processor determines a time difference of when each of the three or more sensors received the sound signal, and wherein, based on the time difference, the processor determines the location of the sound source by applying the law of cosines twice, and wherein the processor determines a velocity and direction of travel for the source based on a Doppler shift of the sound signal.

21. The non-transitory computer readable media of claim 19, wherein the processor compares the received sound signal to a source sound signal stored in a memory in the vehicle to determine a vehicle type for the source of the sound signal, wherein the vehicle type is an emergency vehicle, and wherein alerting the user includes presenting a display in the vehicle that provides an indication where the emergency vehicle is and an action for the user to take to avoid the emergency vehicle.
